(19) United States
(12) Patent Application Publication
(10) Pub. No.: US 2026/0326408 A1
(43) Pub. Date: Oct. 22, 2026

(54) PRODUCT FORMING UNIT FOR DRY-FORMING A CELLULOSE PRODUCT AND METHOD FOR DRY-FORMING A CELLULOSE PRODUCT

(71) Applicant: PULPAC AB, Västra Frölunda (SE)

(72) Inventors: Ove LARSSON, Västra Frölunda (SE); Peter EKWALL, Lerum (SE)

(21) Appl. No.: 19/115,635

(22) PCT Filed: Sep. 26, 2023
(86) PCT No.: PCT/EP2023/076469

§ 371 Date: Mar. 26, 2025

(30) Foreign Application Priority Data
Sep. 27, 2022 (SE) 2251115-8
Dec. 15, 2022 (SE) 2251469-9
Dec. 15, 2022 (SE) 2251470-7
Jun. 12, 2023 (SE) 2350710-6

(51) Int. Cl. B31B 50/59; B31B 50/10; B31B 50/74; B31B 100/00

(52) U.S. Cl. CPC B31B 50/59; B31B 50/102; B31B 50/74; B31B 2100/0022; B31B 2241/005

(57) ABSTRACT

A product forming unit and method for dry-forming a cellulose product from cellulose fibres, where the product forming unit comprises a forming mould having a first mould part and a second mould part forming a forming cavity and a pressure lance comprising a first end and a second end. The second end of the pressure lance is movably arranged relative to the first mould part and/or the second mould part between a first position in the open state of the forming mould and a second position in the closed state of the forming mould.

### TECHNICAL FIELD

The present disclosure relates to a product forming unit comprising a forming mould for dry-forming a cellulose product from cellulose fibres. The disclosure further relates to a method for dry-forming a cellulose product from cellulose fibres in a product forming unit comprising a forming mould.

### BACKGROUND

Cellulose fibres are commonly used as raw material for producing or manufacturing cellulose products. Products formed of cellulose fibres can be used in many different situations where there is a need for sustainable products. A wide range of products can be produced from cellulose fibres and one specific product category relates to cellulose products having a closed bottom portion, such as for example bottles, cups, and containers with a bottom portion.

Product forming units are used when manufacturing cellulose products from raw materials including cellulose fibres, and traditionally cellulose products have been produced by wet-forming methods. A material commonly used for wet-forming cellulose fibre products is wet moulded pulp. Wet-formed products are generally formed by immersing a suction forming mould into a liquid or semi liquid pulp suspension or slurry comprising cellulose fibres, and when suction is applied, a body of pulp is formed with the shape of the desired product by fibre deposition onto the forming mould. With all wet-forming methods, there is a need for drying of the wet moulded product, where the drying process is a time and energy consuming part of the production. The demands on aesthetical, chemical and mechanical properties of cellulose products are increasing, and due to the properties of wet-formed cellulose products, the mechanical strength, flexibility, freedom in material thickness, and chemical properties are limited. It is also difficult in wet-forming processes to control the mechanical properties of the products with high precision.

One development in the field of producing cellulose products, is dry-forming of cellulose products without using wet-forming methods. Instead of forming the cellulose products from a liquid or semi liquid pulp suspension or slurry, cellulose fibres or a cellulose blank structure air-formed from cellulose fibres is used. The cellulose fibres or the cellulose blank structure is inserted into a forming mould and during the dry-forming of the cellulose products, the cellulose fibres are subjected to a high forming pressure and a high forming temperature. One difficulty with dry-forming methods is the problem with an efficient production process, where cellulose products having a closed bottom portion can be produced at high speeds with high quality, especially when forming deep drawn products.

### SUMMARY

An object of the present disclosure is to provide a product forming unit for dry-forming a cellulose product, and a method for dry-forming a cellulose product from cellulose fibres in a product forming unit, where the previously mentioned problems are avoided. This object is at least partly achieved by the features of the independent claims. The dependent claims contain further developments of the product forming unit and the method.

The disclosure concerns a product forming unit for dry-forming a cellulose product from cellulose fibres. The product forming unit comprises a forming mould having a first mould part and a second mould part forming a forming cavity, and a pressure lance comprising a first end and a second end. The first mould part and/or the second mould part are movably arranged for displacing the forming mould between an open state and a closed state. In the open state, the forming mould is configured for receiving the cellulose fibres into the forming cavity. In the closed state, the forming mould is configured for being closed around the cellulose fibres in the forming cavity. The second end of the pressure lance is extending to or partly into the forming cavity, and the second end is connected to and arranged in fluid communication with a flexible membrane arranged in the forming cavity. The second end of the pressure lance is movably arranged relative to the first mould part and/or the second mould part between a first position in the open state and a second position in the closed state.

Advantages with these features are that the product forming unit is enabling an efficient production process, where cellulose products having a closed bottom portion can be produced at high speeds with high quality and finish. The handling of the cellulose fibres is simplified through the use of the movable mould parts in combination with the flexible membrane. The product forming unit can be made more efficient, especially when forming deep drawn products. The pressure lance is efficiently providing a pressure medium to the flexible membrane arranged within the forming cavity of the forming mould for inflating or deflating the flexible membrane in the forming operation process. The movable configuration of the second end of the pressure lance is enabling efficient feeding of cellulose fibres into the open forming mould when the pressure lance is arranged in the first position. In the second position, the second end of the pressure lance is positioned for an efficient forming operation when the forming mould is closed.

In one embodiment, the first mould part is movably arranged relative to the second mould part in a lateral direction of the forming mould, and/or the second mould part is movably arranged relative to the first mould part in the lateral direction of the forming mould. The second end of the pressure lance is movably arranged relative to the first mould part and/or the second mould part at least in the lateral direction of the forming mould. The lateral movements of the parts of the product forming unit is establishing an efficient displacement of the forming mould between the open and closed states. In the open position, the cellulose fibres can easily be provided to the forming cavity and in the closed state efficient forming is enabled.

In one embodiment, a first lateral distance between the second end and the first mould part is greater in the first position than in the second position. A second lateral distance between the second end and the second mould part is greater in the first position than in the second position.

In one embodiment, the first end is pivotably connected to a holding structure. Upon a pivoting movement of the first end relative to the holding structure, the second end is configured for being displaced relative to the first mould part and/or the second mould part. This configuration with a pivoting movement of the first end is enabling an efficient displacement of the second end relative to the first mould part and/or the second mould part. The holding structure is arranged for holding and supporting the first end for a robust pivoting arrangement of the first end.

In one embodiment, the first end is slidingly connected to a holding structure. Upon a sliding movement of the first end relative to the holding structure, the second end is configured for being displaced relative to the first mould part and/or the second mould part. This alternative configuration with a sliding movement of the first end is enabling an efficient displacement of the second end relative to the first mould part and/or the second mould part. The holding structure is arranged for holding and supporting the first end for a robust sliding arrangement of the first end.

In one embodiment, the second mould part is arranged as a stationary mould part and the first mould part is movably arranged relative to the second mould part upon displacement of the forming mould between the open state and the closed state. Upon displacement of the forming mould from the open state to the closed state, the first mould part and the second end of the pressure lance are configured for being displaced towards the second mould part. Upon displacement of the forming mould from the closed state to the open state, the first mould part and the second end of the pressure lance are configured for being displaced away from the second mould part. By arranging the second mould part as a stationary mould part, the construction of the forming mould can be made simpler. A stationary mould part is further securing stability in the forming mould construction for enabling small tolerance levels during forming operations, where the mould parts can meet with high precision.

In one embodiment, the flexible membrane is configured for being inflated with a pressure medium entering from the pressure lance for applying a forming pressure onto the cellulose fibres by pressing the cellulose fibres against the first mould part and the second mould part by means of the inflated flexible membrane. The forming mould is configured for applying a forming temperature onto the cellulose fibres, for dry-forming the cellulose product with a three-dimensional compressed fibre structure having a closed bottom portion and an upper portion. The flexible membrane is when inflated by the pressure medium applying the forming pressure onto the cellulose fibres. Further, the forming pressure together with the forming temperature applied onto cellulose fibres are efficiently forming the closed bottom portion and the upper portion of the cellulose product.

In one embodiment, the forming mould further comprises a first lower mould part and a second lower mould part. Upon displacement of the forming mould from the open state to the closed state, the first mould part is configured for being moved towards the second mould part in a lateral direction of the forming mould and/or the second mould part is configured for being moved towards the first mould part in the lateral direction of the forming mould. Upon displacement of the forming mould from the open state to the closed state, the first lower mould part is configured for being moved towards the second lower mould part in the lateral direction of the forming mould and/or the second lower mould part is configured for being moved towards the first lower mould part in the lateral direction of the forming mould. Upon displacement of the forming mould from the open state to the closed state, the first lower mould part and the second lower mould part are configured for being moved towards the flexible membrane in a longitudinal direction of the forming mould. The lower mould parts are used for an efficient forming process, where the lower mould parts are displaced in the longitudinal direction towards the flexible membrane. In this way, the cellulose fibres are efficiently distributed in the forming mould.

In one embodiment, the flexible membrane is configured for being inflated with a pressure medium entering from the pressure lance for applying a forming pressure onto the cellulose fibres by pressing the cellulose fibres against the first mould part, the second mould part, the first lower mould part and the second lower mould part by means of the inflated flexible membrane. The forming mould is configured for applying a forming temperature onto the cellulose fibres, for dry-forming the cellulose product with a three-dimensional compressed fibre structure having a closed bottom portion and an upper portion. The flexible membrane is when inflated by the pressure medium applying the forming pressure onto the cellulose fibres. Further, the forming pressure together with the forming temperature applied onto cellulose fibres are efficiently forming the closed bottom portion and the upper portion of the cellulose product.

In one embodiment, the first lower mould part is movably connected to the first mould part and configured for being displaced relative to the first mould part in the longitudinal direction of the forming mould. The second lower mould part is movably connected to the second mould part and configured for being displaced relative to the second mould part in the longitudinal direction of the forming mould. This configuration is enabling a simple construction and an efficient displacement of the lower mould parts relative to the first and second mould parts respectively.

In one embodiment, the product forming unit comprises a pre-forming mould arranged upstream the forming mould. The pre-forming mould comprises an outer mould part and an inner mould part arranged around a forming section of the pressure lance. A forming cavity is formed between the outer mould part, the inner mould part, and the forming section. The forming section of the pressure lance is movably arranged relative to the outer mould part and/or the inner mould part between a first position in an open state of the pre-forming mould and a second position in a closed state of the pre-forming mould. The product forming unit with the pre-forming mould is enabling an efficient production process, where cellulose products with high quality can be produced at high speeds. The forming mould together with the pre-forming mould is used for efficiently producing cellulose products with high finish at increased production rates. In this way, a more efficient forming unit for producing high-quality cellulose products is achieved by the two forming moulds.

In one embodiment, the product forming unit comprises a shaping unit and a feeding unit. The shaping unit is configured for shaping a cellulose blank structure air-formed from the cellulose fibres into a shaped cellulose blank structure having a tube-like configuration upstream the forming mould. The feeding unit is configured for feeding the shaped cellulose blank structure around the pressure lance and flexible membrane into the forming mould, or the feeding unit is configured for feeding the shaped cellulose blank structure around the pressure lance and flexible membrane into the pre-forming mould and into the forming mould. The shaping unit is thus shaping the cellulose blank structure into a shaped cellulose blank structure for an efficient handling and feeding of the cellulose blank structure to the forming mould. The feeding unit is efficiently feeding the shaped cellulose blank structure around the pressure lance and flexible membrane into the forming mould. The shaped cellulose blank structure is further enabling an efficient positioning of the cellulose fibres in the forming mould.

In one embodiment, the dry-formed cellulose product comprises a neck portion. The upper portion is arranged between the closed bottom portion and the neck portion. The upper portion is arranged in fluid communication with the neck portion. The feeding unit is configured for feeding the shaped cellulose blank structure to the pre-forming mould. The pre-forming mould is configured for forming a neck portion of a leading cellulose product simultaneously with forming a semi-closed bottom portion of a directly following trailing cellulose product from the shaped cellulose blank structure. The product forming unit is enabling an efficient production process, where cellulose products with high quality can be produced at high speeds. The handling of the air-formed cellulose blank structure is simplified through use of the shaped cellulose blank structure having the tube-like configuration, and the pre-forming mould is used for efficiently producing cellulose products with high finish at increased production rates. In this way, a more efficient forming unit for producing high-quality cellulose products is achieved. The simultaneous forming of the semi-closed bottom portion of the cellulose product and the neck portion of a directly preceding cellulose product from the shaped cellulose blank structure is providing a unique and fast forming operation.

In one embodiment, the feeding unit is configured for feeding the shaped cellulose blank structure around the pressure lance and through the outer mould part and the inner mould part when the pre-forming mould is arranged in the open state. The outer mould part and the inner mould part are when arranged in the closed state configured for pressing the shaped cellulose blank structure against the pressure lance for simultaneously forming the neck portion and the semi-closed bottom portion in the forming cavity. In this way, the forming section of the pressure lance extending through the forming cavity is forming part of the pre-forming mould, and the forming section of the pressure lance is used for an efficient forming of the neck portion and the semi-closed bottom portion in the forming cavity. During the pressing operation, a forming pressure and a forming temperature are applied onto a part of the shaped cellulose blank structure used for forming the neck portion in the forming cavity, for an efficient forming operation in the pre-forming mould.

In one embodiment, the outer mould part and the inner mould part of the pre-forming mould comprises a thread forming section configured for forming a threaded section of the neck portion upon forming of the neck portion in the pre-forming mould. The thread forming section comprises a threaded pattern for efficient forming of the threaded section of the neck portion in the pre-forming mould.

In one embodiment, the feeding unit is configured for feeding a formed semi-closed bottom portion and an intermediate section of the shaped cellulose blank structure between the formed semi-closed bottom portion and a directly following formed trailing neck portion from the pre-forming mould to the forming mould. The forming mould is configured for forming the upper portion from the intermediate section and forming the closed bottom portion from the semi-closed bottom portion. The forming mould is in this way used for an efficient forming of the upper portion of the cellulose product from the intermediate section and forming the closed bottom portion of the cellulose product from the semi-closed bottom portion after the forming operations in the pre-forming mould. The mould parts of the forming mould together with the flexible membrane, when the mould parts are closed around the shaped cellulose blank structure, are forming the upper portion and the closed bottom portion by inflating the flexible membrane with the pressure medium entering from the pressure lance, where the semi-closed bottom portion and the intermediate section are pressed against the mould parts by means of the inflated flexible membrane. Further, the applied forming pressure together with the applied second forming temperature onto the semi-closed bottom portion and the intermediate section are efficiently forming the closed bottom portion and the upper portion of the cellulose product.

In one embodiment, the product forming unit comprises a fluid control device. The pressure lance is at the first end arranged in fluid communication with the fluid control device. The fluid control device is configured for inflating the flexible membrane with the pressure medium via the pressure lance. The fluid control device is further arranged for deflating the flexible membrane via the pressure lance after the forming operation in the forming mould. The fluid control device may have any suitable configuration, and may comprise hydraulic or pneumatic cylinders, fluid pumps, compressors, or other pressure establishing devices for delivering pressurized pressure medium to the flexible membrane via the pressure lance.

The disclosure further concerns a method for dry-forming a cellulose product from cellulose fibres in a product forming unit. The product forming unit comprises a forming mould having a first mould part and a second mould part forming a forming cavity, and a pressure lance comprising a first end and a second end. The second end of the pressure lance is extending to or partly into the forming cavity, and the second end is connected to and arranged in fluid communication with a flexible membrane arranged in the forming cavity. The first mould part and/or the second mould part are movably arranged. The second end of the pressure lance is movably arranged relative to the first mould part and/or the second mould part. The method comprises the steps: displacing the first mould part and/or the second mould part for arranging the forming mould into an open state, and displacing the second end of the pressure lance relative to the first mould part and/or the second mould part into a first position in the open state, where in the open state the forming mould is configured for receiving the cellulose fibres into the forming cavity; displacing the first mould part and/or the second mould part for arranging the forming mould into a closed state, and displacing the second end of the pressure lance relative to the first mould part and/or the second mould part into a second position in the closed state, where in the closed state the forming mould is closed around the cellulose fibres in the forming cavity.

Advantages with these features are that the method is enabling an efficient production process, where cellulose products having a closed bottom portion can be produced at high speeds with high quality and finish. The handling of the cellulose fibres is simplified through the use of the movable mould parts in combination with the flexible membrane. The product forming unit can be made more efficient, especially when forming deep drawn products. The pressure lance is efficiently providing a pressure medium to the flexible membrane arranged within the forming cavity of the forming mould for inflating or deflating the flexible membrane in the forming operation process. The movable configuration of the second end of the pressure lance is enabling efficient feeding of cellulose fibres into the open forming mould when the pressure lance is arranged in the first position. In the second position, the second end of the pressure lance is positioned for an efficient forming operation when the forming mould is closed.

In one embodiment, the method further comprises the steps: moving the first mould part relative to the second mould part in a lateral direction of the forming mould and/or moving the second mould part relative to the first mould part in the lateral direction of the forming mould upon displacement of the forming mould between the open position and the closed position. The second end of the pressure lance is movably arranged relative to the first mould part and/or the second mould part at least in the lateral direction of the forming mould upon displacement of the forming mould between the open position and the closed position. The lateral movements of the parts of the product forming unit is establishing an efficient displacement of the forming mould between the open and closed states. In the open position, the cellulose fibres can easily be provided to the forming cavity and in the closed state efficient forming is enabled.

In one embodiment, a first lateral distance between the second end and the first mould part is greater in the first position than in the second position. A second lateral distance between the second end and the second mould part is greater in the first position than in the second position.

In one embodiment, the first end is pivotably connected to a holding structure. The method further comprises the step: pivoting the first end relative to the holding structure, where the pivoting movement of the first end relative to the holding structure is displacing the second end relative to the first mould part and/or the second mould part. This configuration with a pivoting movement of the first end is enabling an efficient displacement of the second end relative to the first mould part and/or the second mould part. The holding structure is arranged for holding and supporting the first end for a robust pivoting arrangement of the first end.

In one embodiment, the first end is slidingly connected to a holding structure. The method further comprises the step: sliding the first end relative to the holding structure, where the sliding movement of the first end relative to the holding structure is displacing the second end relative to the first mould part and/or the second mould part. This alternative configuration with a sliding movement of the first end is enabling an efficient displacement of the second end relative to the first mould part and/or the second mould part. The holding structure is arranged for holding and supporting the first end for a robust sliding arrangement of the first end.

In one embodiment, the second mould part is arranged as a stationary mould part and the first mould part is movably arranged relative to the second mould part upon displacement of the forming mould between the open state and the closed state. The method further comprises the steps: displacing the forming mould from the open state to the closed state, where upon displacement of the forming mould from the open state to the closed state the first mould part and the second end of the pressure lance are displaced towards the second mould part; displacing the forming mould from the closed state to the open state, where upon displacement of the forming mould from the closed state to the open state the first mould part and the second end of the pressure lance are displaced away from the second mould part. By arranging the second mould part as a stationary mould part, the construction of the forming mould can be made simpler. A stationary mould part is further securing stability in the forming mould construction for enabling small tolerance levels during forming operations, where the mould parts can meet with high precision.

In one embodiment, the method further comprises the steps: inflating the flexible membrane with a pressure medium entering from the pressure lance for applying a forming pressure onto the cellulose fibres by pressing the cellulose fibres against the first mould part and the second mould part by means of the inflated flexible membrane in the closed state, and in the closed state applying a forming temperature onto the cellulose fibres in the forming mould for dry-forming the cellulose product with a three-dimensional compressed fibre structure having a closed bottom portion and an upper portion. The flexible membrane is when inflated by the pressure medium applying the forming pressure onto the cellulose fibres. Further, the forming pressure together with the forming temperature applied onto cellulose fibres are efficiently forming the closed bottom portion and the upper portion of the cellulose product.

In one embodiment, the product forming unit comprises a pre-forming mould arranged upstream the forming mould. The pre-forming mould comprises an outer mould part and an inner mould part arranged around a forming section of the pressure lance. A forming cavity is formed between the outer mould part, the inner mould part, and the forming section. The forming section of the pressure lance is movably arranged relative to the outer mould part and/or the inner mould part. The method further comprises the steps: displacing the outer mould part and/or the inner mould part for arranging the pre-forming mould into an open state, and displacing the forming section of the pressure lance relative to the outer mould part and/or the inner mould part into a first position in the open state of the pre-forming mould, where in the open state the pre-forming mould is configured for receiving the cellulose fibres into the forming cavity; displacing the outer mould part and/or the inner mould part for arranging the pre-forming mould into a closed state, and displacing the forming section of the pressure lance relative to the outer mould part and/or the inner mould part into a second position in the closed state of the pre-forming mould, where in the closed state the pre-forming mould is closed around the cellulose fibres in the forming cavity. The product forming unit with the pre-forming mould is enabling an efficient production process, where cellulose products with high quality can be produced at high speeds. The forming mould together with the pre-forming mould is used for efficiently producing cellulose products with high finish at increased production rates. In this way, a more efficient forming unit for producing high-quality cellulose products is achieved by the two forming moulds.

### BRIEF DESCRIPTION OF DRAWINGS

The disclosure will be described in detail in the following, with reference to the attached drawings, in which

FIG. 1a-b show schematically, in side views, a product forming unit comprising a forming mould in an open state and in a closed state,

FIG. 2a-f show schematically, in side views, the product forming unit in different operational forming steps,

FIG. 3 shows schematically, in a perspective view, an alternative product forming unit with a pre-forming mould and a forming mould,

FIG. 4a-f show schematically, in a perspective view from above and a perspective view from below, a cellulose product formed in the alternative product forming unit; and in side views and in a perspective view, a shaped cellulose blank structure in different forming steps,

FIG. 5a-e show schematically, in perspective views from above, the pre-forming mould of the alternative product forming unit in different operational steps,

FIG. 6a-f show schematically, in side views, the forming mould of the alternative product forming unit in different operational steps,

FIG. 7a-f show schematically, in perspective views, the alternative product forming unit with the pre-forming mould and the forming mould in different operational steps,

FIG. 8a-b show schematically, in perspective views, movable configurations of a pressure lance of the forming mould unit.

### DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

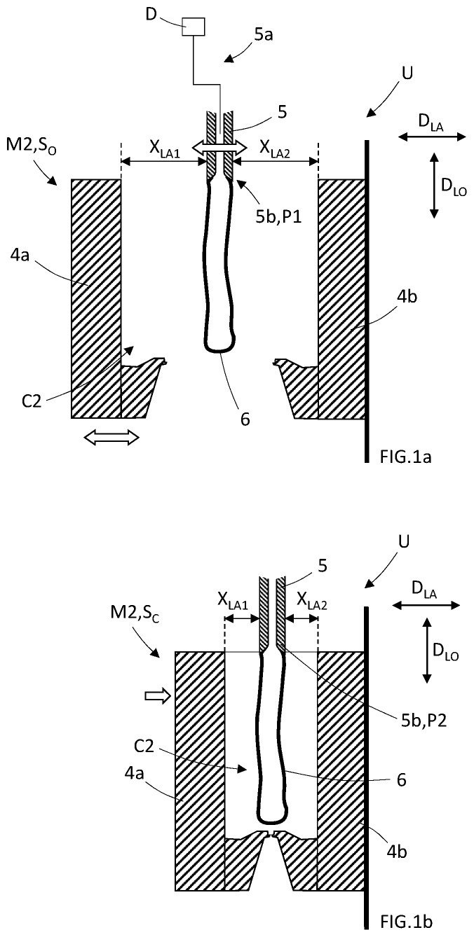

FIGS. 1a-b and 2a-f schematically show an embodiment of a product forming unit U for dry-forming cellulose products 1 from cellulose fibres CF. The product forming unit U comprises a forming mould M2. The product forming unit U is arranged for dry-forming the cellulose product 1 from the cellulose fibres CF in different operational steps in the forming mould M2 for an efficient product forming process. The forming mould M2 has an extension in a longitudinal direction D_{LO} and a lateral direction D_{LA}.

As illustrated in FIGS. 1a-b, the forming mould M2 comprises a first mould part 4a and a second mould part 4b that together are forming a forming cavity C2. The first mould part 4a and/or the second mould part 4b are movably arranged at least in the lateral direction D_{LA} of the forming mould M2 for displacing the forming mould M2 between an open state S_{O} and a closed state S_{C}. In the open state S_{O}, the forming mould M2 is configured for receiving cellulose fibres CF into the forming cavity C2, and in the closed state S_{C} the forming mould M2 is configured for being closed around the cellulose fibres CF in the forming cavity C2.

The product forming unit U further comprises a pressure lance 5 having a first end 5a and a second end 5b. The second end 5b of the pressure lance 5 is extending to or partly into the forming cavity C2, and the second end 5b is connected to and arranged in fluid communication with a flexible membrane 6 arranged in the forming cavity C2. A pressure medium P is used for inflating the flexible membrane 6 when dry-forming the cellulose products 1, as will be further explained below.

In the embodiment shown in FIGS. 1a-b, the first mould part 4a is movably arranged in the lateral direction D_{LA} of the forming mould M2, as indicated with the double arrow in FIG. 1a. The first mould part 4a is when moved displacing the forming mould M2 between the open state S_{O}, as illustrated in FIG. 1a, and the closed state S_{C}, as illustrated in FIG. 1b. The second mould part 4b is arranged as a stationary or non-movable mould part.

This configuration of the forming mould M2 illustrated in FIGS. 1a-b, where the second mould part 4b is arranged as a stationary mould part and the first mould part 4a is movably arranged relative to the second mould part 4b upon displacement of the forming mould M2 between the open state S_{O} and the closed state S_{C}, is enabling an efficient and rigid construction of the forming mould M2 where only one mould part needs to be displaced. Upon displacement of the forming mould M2 from the open state S_{O} to the closed state S_{C}, the first mould part 4a and the second end 5b of the pressure lance 5 are configured for being displaced towards the second mould part 4b, as understood from FIGS. 1a-b. Upon displacement of the forming mould M2 from the closed state S_{C} to the open state S_{O} the first mould part 4a and the second end 5b of the pressure lance 5 are configured for being displaced away from the second mould part 4b.

The product forming unit U further comprises a fluid control device D. The first end 5a of the pressure lance 5 is arranged in fluid communication with the fluid control device D, as schematically indicated in FIG. 1a, and the fluid control device D is configured for inflating the flexible membrane 6 with the pressure medium P via the pressure lance 5. The fluid control device D is further arranged for deflating the flexible membrane 6 via the pressure lance 5 after the forming operation in the forming mould M2. The fluid control device D may have any suitable configuration, and may comprise hydraulic or pneumatic cylinders, fluid pumps, compressors, or other pressure establishing devices for delivering pressurized pressure medium P to the flexible membrane 6 via the pressure lance 5. The product forming unit U may further comprise a control unit for controlling the forming operation.

The second end 5b of the pressure lance 5 is movably arranged relative to the first mould part 4a and/or the second mould part 4b between a first position P₁ in the open state S_{O} and a second position P₂ in the closed state S_{C}. Suitably, the second end 5b of the pressure lance 5 is movably arranged relative to the first mould part 4a and/or the second mould part 4b at least in the lateral direction D_{LA}. The flexible membrane 6 is moved with the second end 5b of the pressure lance 5 upon displacement between the first position P₁ and the second position P₂, as shown in FIGS. 1a-b.

In the embodiment shown in FIGS. 1a-b, the second end 5b of the pressure lance 5 is movably arranged in the lateral direction D_{LA} relative to both the first mould part 4a and the second mould part 4b between the first position P₁ in the open state S_{O} and the second position P₂ in the closed state S_{C}, as indicated with the double arrow in FIG. 1a. The movable configuration of the pressure lance 5 is enabling efficient feeding of cellulose fibres CF into the open forming mould M2 when the pressure lance 5 is arranged in the first position P₁. In the second position P₂, the pressure lance 5 is positioned for an efficient forming operation when the forming mould M2 is closed.

In the first position P₁ and the second position P₂ shown in FIGS. 1a-b, the first mould part 4a is positioned a first lateral distance X_{LA1} from the second end 5b of the pressure lance 5, and the second mould part 4b is positioned a second lateral distance X_{LA2} from the second end 5b of the pressure lance 5. As understood from the figures, the first lateral distance X_{LA1} and the second lateral distance X_{LA2} iS different in the two positions, such that the first lateral distance X_{LA1} between the second end 5b and the first mould part 4a is greater in the first position P₁ than in the second position P₂, and the second lateral distance X_{LA2} between the second end 5b and the second mould part 4b is greater in the first position P₁ than in the second position P₂. This positioning of the second end 5b relative to the first mould part 4a and the second mould part 4b respectively may be applied also if both mould parts are movably arranged.

The flexible membrane 6 is in the closed state S_{C} inflated with a pressure medium P entering from the pressure lance 5 for applying a forming pressure P_{F2} onto the cellulose fibres CF by pressing the cellulose fibres CF against the first mould part 4a and the second mould part 4b by means of the inflated flexible membrane 6. The forming mould M2 is in the closed state S_{C} applying a forming temperature T_{F2} onto the cellulose fibres CF. Through the application of the forming pressure P_{F} and the forming temperature T_{F}, the cellulose fibres are dry-formed into a cellulose product 1 having a three-dimensional compressed fibre structure CF_{CS} with a closed bottom portion 1c and an upper portion 1b, as will be further described below.

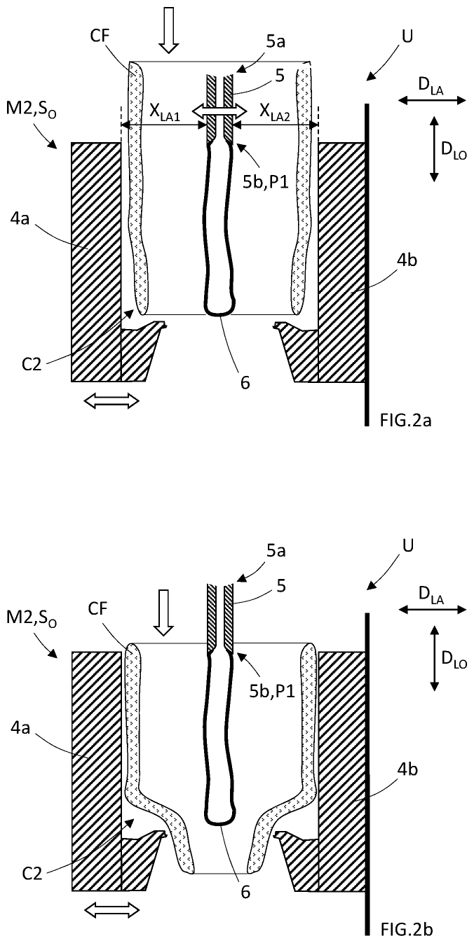

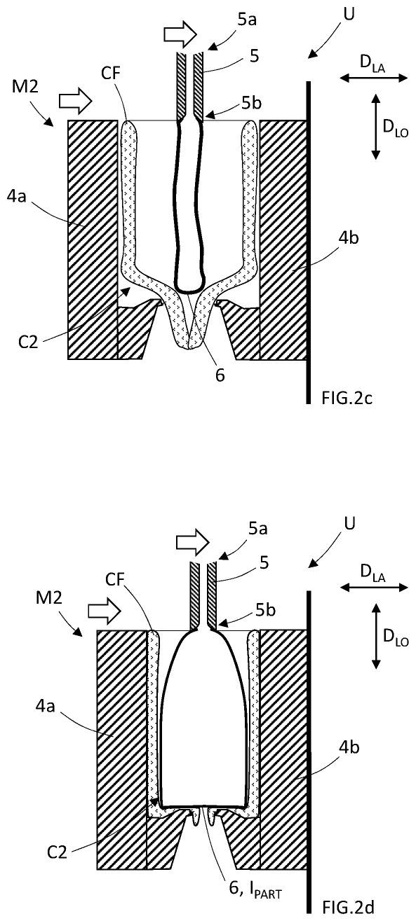

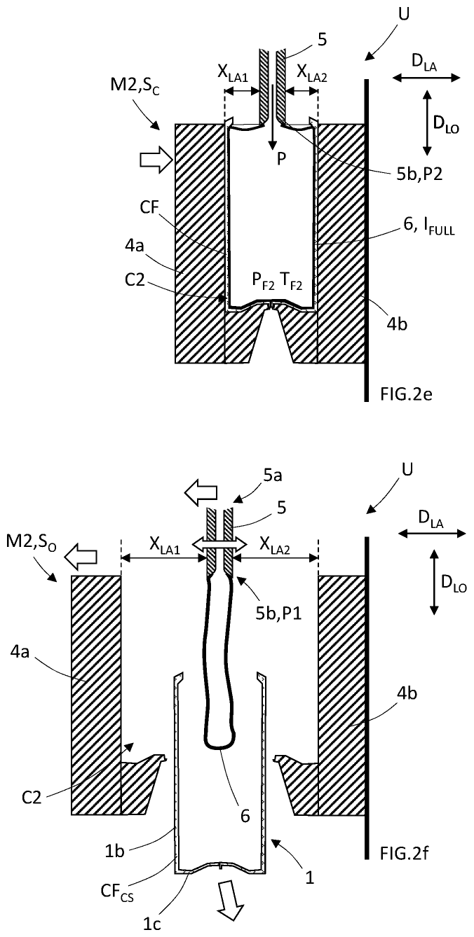

The dry-forming operation of cellulose product 1 from cellulose fibres CF in the product forming unit U comprising the forming mould M2 will described more in detail with reference to FIGS. 2a-f. The product forming unit U has the same configuration as described above in connection to FIGS. 1a-b. The first mould part 4a is movably arranged in the lateral direction D_{LA} of the forming mould M2, as indicated with the double arrow in FIG. 2a. The first mould part 4a is when moved displacing the forming mould M2 between the open state S_{O}, as illustrated in FIG. 2a, and the closed state S_{C}, as illustrated in FIG. 2e. The second mould part 4b is arranged as a stationary or non-movable mould part. The first mould part 4a is suitably displaceable in the lateral direction D_{LA} in reciprocating linear movements towards and away from the second mould part 4b and the flexible membrane 6.

In FIG. 2a, the forming mould M2 is arranged in the open state S_{O}, where the first mould part 4a has been displaced in the lateral direction D_{LA} away from the second mould part 4b, and away from the flexible membrane 6. In the open state S_{O}, the second end 5b of the pressure lance 5 has been displaced in the lateral direction D_{LA} into the first position P₁ away from the second mould part 4b, where the cellulose fibres CF are fed around the flexible membrane 6 and received between the first mould part 4a and second mould part 4b, as shown in FIGS. 2a-b. The cellulose fibres CF may be fed into the forming mould M2 with any suitable feeding or transporting means. The cellulose fibres CF may suitably be air-formed into a body of cellulose fibres CF, such as a shaped cellulose blank structure, before being fed to the forming mould M2, as schematically shown in FIGS. 2a-b. The air-formed cellulose fibres CF may be arranged into the forming mould M2 with any suitable transportation means.

In the forming cavity C2 of the forming mould M2, the cellulose product 1 is dry-formed from the cellulose fibres CF into a three-dimensional compressed fibre structure CF_{CS} having an upper portion 1b and a closed bottom portion 1c, as shown in FIG. 2f.

When the cellulose fibres CF have been arranged in the open forming mould M2, as shown in FIG. 2b, the forming mould M2 is closed around the cellulose fibres CF. Upon closing of the forming mould M2, the first mould parts 4a is moved towards the second mould part 4b in the lateral direction D_{LA}.

In FIG. 2b, the body of cellulose fibres CF has been positioned between the first mould part 4a and the second mould part 4b, with the flexible membrane 6 arranged inside the body of cellulose fibres CF. Thereafter, the forming mould M2 is displaced from the open state S_{O} to a closed state S_{C}. As shown in FIGS. 2c-d, the first mould part 4a and the second end 5c of the pressure lance 5 are moved towards the second mould part 4b in the lateral direction D_{LA} as indicated with the arrows. In FIG. 2e, the forming mould M2 is arranged in the closed state S_{C}, in which the cellulose fibres CF can be dry-formed into the cellulose product 1. In the closed state S_{C}, the second end 5b of the pressure lance 5 is arranged in the second position P₂.

In the first position P₁ shown in FIG. 2a and the second position P₂ shown in FIG. 2e, the first mould part 4a is positioned a first lateral distance X_{LA1} from the second end 5b of the pressure lance 5, and the second mould part 4b is positioned a second lateral distance X_{LA2} from the second end 5b of the pressure lance 5. As understood from the figures, the first lateral distance X_{LA1} and the second lateral distance X_{LA2} is different in the two positions, such that the first lateral distance X_{LA1} between the second end 5b and the first mould part 4a is greater in the first position P₁ than in the second position P₂, and the second lateral distance X_{LA2} between the second end 5b and the second mould part 4b is greater in the first position P₁ than in the second position P₂.

Upon movement of the first mould part 4a and the second end 5b of the pressure lance 5 in the lateral direction D_{LA}, the flexible membrane 6 may be partly inflated with the pressure medium P into a partly inflated state I_{PART}, as shown in FIG. 2d. In the partly inflated state I_{PART}, the partly inflated flexible membrane 6 is pushing the cellulose fibres CF towards the first mould part 4a and second mould part 4b for an efficient distribution of the cellulose fibres in the forming cavity C2. The partly inflated flexible membrane 6 is thus enabling an efficient distribution of the cellulose fibres CF in the forming cavity C2 upon movement of the first mould part 4a. During the closing of the forming mould M2, the cellulose fibres CF are pushed towards a closed bottom configuration by means of the first mould part 4a and second mould part 4b, for pre-shaping the closed bottom portion 1c by the forces exerted by the mould parts.

When the forming mould is arranged in the closed state S_{C}, the flexible membrane 6 is further inflated into a fully inflated state I_{FULL} for establishing a forming pressure P_{F2} for an efficient dry-forming operation of the cellulose product 1 in the forming mould M2, as shown in FIG. 2e. Thus, when the forming mould M2 is closed around the cellulose fibres CF, the flexible membrane 6 is fully inflated with the pressure medium P for applying the forming pressure P_{F2} onto the cellulose fibres CF. The flexible membrane 6 is inflated with the pressure medium P entering from the pressure lance 5, and the forming pressure P_{F2} is applied onto the cellulose fibres CF by pressing the cellulose fibres CF against the first mould part 4a and second mould part 4b by means of the inflated flexible membrane 6. A forming temperature T_{F2} is applied onto the cellulose fibres CF in the forming mould M2. In this way the forming pressure P_{F2} and the forming temperature T_{F2} are enabling the dry-forming of the cellulose product 1 into a three-dimensional compressed fibre structure CF_{CS} having a closed bottom portion 1c and an upper portion 1b.

The applied forming pressure P_{F2} in the forming mould M2 is suitably in the range of 1-100 MPa, preferably 4-20 MPa, and the applied forming temperature T_{F2} is suitably in the range of 60-300 °C, preferably 100-200 °C.

After the forming operation, the forming mould M2 is returned to the open state S_{O}, as shown in FIG. 2f, for an easy removal of the cellulose product 1 from the forming mould M2 and for repeating the dry-forming operation. After forming of the cellulose product 1, the flexible membrane 6 is deflated and the forming mould M2 is opened. Upon opening the forming mould M2, the first mould part 4a and the second end 5b of the pressure lance are moved away from the second mould part 4b in the lateral direction D_{LA} as indicated with the arrows in FIG. 2f. In this way, the second end 5b of the pressure lance 5 is returned to the first position P₁.

The first mould part 4a and second mould part 4b of the forming mould M2 are suitably arranged as stiff mould parts. With stiff mould parts is meant that the mould parts are made of a stiff material with limited deformation capabilities, such as for example steel, aluminium, composite materials or a combination of different materials.

The second mould part M2 may further comprise a non-illustrated heating unit. The heating unit is configured for applying the second forming temperature T_{F2} onto the cellulose fibres CF during the forming operation in the forming mould M2. The heating unit may have any suitable configuration. The heating unit may be integrated in or cast into the mould parts, and suitable heating devices are e.g. electrical heaters, such as resistor elements, or fluid heaters. Other suitable heat sources may also be used.

The flexible membrane 6 is made of a material that is allowed to deform when being inflated upon dry-forming of the cellulose products 1 in the forming mould M2. Suitable materials are for example elastomeric compositions, such as for example rubber, or other elastomers exhibiting elastic or rubber-like properties. The material used in the flexible membrane 6 suitably withstands high pressure levels from the pressure medium P when being inflated, as well as repeated inflation and deflation cycles.

In other non-illustrated embodiments, the flexible membrane 6 may be made of a liquid impermeable single-use plastic film or other suitable material that is adhering to the cellulose product 1 during the forming process. In this way, the plastic film or other suitable material is forming a liquid barrier inside the formed cellulose product 1. With this configuration, a new flexible membrane 6 is provided for each product forming operation in the forming mould M2.

The pressure medium P is used for establishing the second forming pressure P_{F2} in the forming cavity C2 upon inflating the flexible membrane 6. The pressure medium P used in the forming operation in the forming mould M2 may be a liquid composition or a gas, such as for example oil, water, or air. In the embodiment described above, where the flexible membrane 6 is made of a single-use plastic film or other suitable material that is adhering to the cellulose product 1 during the forming process, the pressure medium P may be a beverage or other liquid that is pressurizing the flexible membrane 6 when forming the cellulose product 1. In this way, the beverage or other liquid is directly filled into the cellulose product 1 during the forming process.

In other embodiments, the forming mould M2 may have a different configuration. The forming mould M2 may comprise a first lower mould part 4c and a second lower mould part 4d in addition to the first mould part 4a and the second mould part 4b. With such a configuration, the first mould part 4a is configured for being moved towards the second mould part 4b in the lateral direction D_{LA} and/or the second mould part 4b is configured for being moved towards the first mould part 4b in the lateral direction D_{LA} upon displacement of the forming mould M2 from the open state S_{O} to the closed state S_{C}. The first lower mould part 4c is configured for being moved towards the second lower mould part 4d in the lateral direction D_{LA} and/or the second lower mould part 4d is configured for being moved towards the first lower mould part 4c in the lateral direction D_{LA} upon displacement of the forming mould M2 from the open state S_{O} to the closed state S_{C}. Further, the first lower mould part 4c and the second lower mould part 4d are configured for being moved towards the flexible membrane 6 in a longitudinal direction D_{LO} upon displacement of the forming mould M2 from the open state S_{O} to the closed state S_{C}.

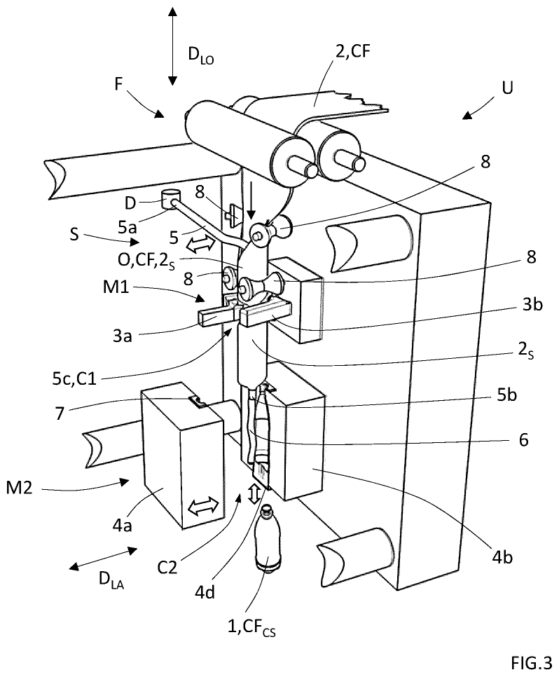

FIG. 3 schematically shows an alternative embodiment of a product forming unit U for dry-forming a cellulose product 1 from a cellulose blank structure 2 air-formed from cellulose fibres CF. In this embodiment, the cellulose product 1 is exemplified as a cellulose bottle. The product forming unit U comprises a feeding unit F, a shaping unit S, a pre-forming mould M1, and a forming mould M2 arranged downstream the pre-forming mould M1. The product forming unit U is arranged for dry-forming the cellulose product 1 from the cellulose blank structure 2 in different operational steps in the pre-forming mould M1 and the forming mould M2 for an efficient product forming process. In the embodiment illustrated in FIG. 3, the pre-forming mould M1 is positioned above the forming mould M2, and the pre-forming mould M1 is in this way arranged upstream the forming mould M2. It should however be understood that the product forming unit U in other non-illustrated embodiments may be positioned in other ways, where the pre-forming mould M1 is arranged upstream the forming mould M2.

In the embodiment illustrated in FIG. 3, the forming mould M2 comprises a first lower mould part 4c and a second lower mould part 4d in addition to the first mould part 4a and the second mould part 4b. Upon displacement of the forming mould M2 from the open state S_{O} to the closed state S_{C} the first mould part 4a is configured for being moved towards the second mould part 4b in the lateral direction D_{LA} and the first lower mould part 4c is configured for being moved towards the second lower mould part 4d in the lateral direction D_{LA}. Further, upon displacement of the forming mould M2 from the open state S_{O} to the closed state S_{C}, the first lower mould part 4c and the second lower mould part 4d are configured for being moved towards the flexible membrane 6 in a longitudinal direction D_{LO}. Suitably, the first lower mould part 4c is movably connected to the first mould part 4a and configured for being displaced relative to the first mould part 4a in the longitudinal direction D_{LO}, and the second lower mould part 4d is movably connected to the second mould part 4b and configured for being displaced relative to the second mould part 4b in the longitudinal direction D_{LO}.

The product forming unit U in the embodiment shown in FIG. 3 further comprises a pressure lance 5 having a first end 5a and a second end 5b. The second end 5b of the pressure lance 5 is extending to or partly into the forming cavity C2 of the forming mould M2, and the second end 5b is connected to and arranged in fluid communication with a flexible membrane 6 arranged in the forming cavity C2. A pressure medium P is used for inflating the flexible membrane 6 when dry-forming the cellulose products 1.

In the embodiment shown in FIG. 3, the first mould part 4a is movably arranged in the lateral direction D_{LA} of the forming mould M2. The first mould part 4a is when moved displacing the forming mould M2 between the open state S_{O} and the closed state S_{C}. The second mould part 4b is arranged as a stationary or non-movable mould part. Upon displacement of the forming mould M2 from the open state S_{O} to the closed state S_{C}, the first mould part 4a together with the first lower mould part 4c and the second end 5b of the pressure lance 5 are configured for being displaced towards the second mould part 4b in the lateral direction D_{LA}. Upon displacement of the forming mould M2 from the closed state S_{C} to the open state S_{O} the first mould part 4a with the first lower mould part 4c and the second end 5b of the pressure lance 5 are configured for being displaced away from the second mould part 4b in the lateral direction D_{LA}.

The product forming unit U further comprises a fluid control device D. The first end 5a of the pressure lance 5 is arranged in fluid communication with the fluid control device D, as schematically indicated in FIG. 3, and the fluid control device D is configured for inflating the flexible membrane 6 with the pressure medium P via the pressure lance 5. The fluid control device D is further arranged for deflating the flexible membrane 6 via the pressure lance 5 after the forming operation in the forming mould M2. The fluid control device D may have any suitable configuration, and may comprise hydraulic or pneumatic cylinders, fluid pumps, compressors, or other pressure establishing devices for delivering pressurized pressure medium P to the flexible membrane 6 via the pressure lance 5. The product forming unit U may further comprise a control unit for controlling the forming operation. The second end 5b of the pressure lance 5 is movably arranged in the lateral direction D_{LA} relative to the first mould part 4a and the second mould part 4b between a first position P₁ in the open state S_{O} and a second position P₂ in the closed state S_{C}.

The flexible membrane 6 is configured for being inflated with a pressure medium P entering from the pressure lance 5 for applying a forming pressure P_{F2} onto the cellulose fibres CF by pressing the cellulose fibres CF against the first mould part 4a, the second mould part 4b, the first lower mould part 4c and the second lower mould part 4d by means of the inflated flexible membrane 6. The forming mould M2 is configured for applying a forming temperature T_{F2} onto the cellulose fibres CF. Through the application of the forming pressure P_{F} and the forming temperature T_{F}, the cellulose fibres are dry-formed into a cellulose product 1 having a three-dimensional compressed fibre structure CF_{CS} with a closed bottom portion 1c and an upper portion 1b, as will be further described below.

With an air-formed cellulose blank structure 2 is meant an essentially air-formed fibrous web structure produced from cellulose fibres CF, where the cellulose fibres CF are air-formed into the cellulose blank structure 2. The cellulose fibres CF may originate from a suitable cellulose raw material, such as a pulp material. Suitable pulp materials are for example fluff pulp, paper structures, or other cellulose fibre-containing structures. With air-forming of the cellulose blank structure 2 is meant the formation of a cellulose blank structure in a dry-forming process in which the cellulose fibres CF are air-formed to produce the cellulose blank structure 2. When air-forming the cellulose blank structure 2 in the air-forming process, the cellulose fibres CF are carried and formed to the fibre blank structure 2 by air as carrying medium. This is different from a normal papermaking process or a traditional wet-forming process, where water is used as carrying medium for the cellulose fibres CF when forming the paper or fibre structure. In the air-forming process, small amounts of water or other substances may if desired be added to the cellulose fibres CF in order to change the properties of the cellulose products, but air is still used as carrying medium in the forming process. The cellulose blank structure 2 may, if suitable have a dryness that is mainly corresponding to the ambient humidity in the atmosphere surrounding the air-formed cellulose blank structure 2. As an alternative, the dryness of the cellulose blank structure 2 can be controlled in order to have a suitable dryness level when forming the cellulose products 1.

The cellulose blank structure 2 may have a composition where the fibres are of the same origin or alternatively contain a mix of two or more types of cellulose fibres, depending on the desired properties of the cellulose products 1. The cellulose fibres CF used in the cellulose blank structure 2 are during the forming process of the cellulose products 1 strongly bonded to each other. The cellulose fibres CF may be mixed with other substances or compounds to a certain amount as will be further described below. With cellulose fibres CF is meant any type of cellulose fibres, such as natural cellulose fibres or manufactured cellulose fibres. The cellulose blank structure 2 may specifically comprise at least 95% cellulose fibres CF, or more specifically at least 99% cellulose fibres CF. However, the cellulose blank structure 2 may have other suitable configurations and cellulose fibre amounts.

The air-formed cellulose blank structure 2 may have a single-layer or a multi-layer configuration. A cellulose blank structure 2 having a single-layer configuration is referring to a structure that is formed of one layer containing cellulose fibres. A cellulose blank structure 2 having a multi-layer configuration is referring to a structure that is formed of two or more layers comprising cellulose fibres, where the layers may have the same or different compositions or configurations.

One or more reinforcement layers comprising cellulose fibres may be added to the cellulose blank structure 2. The one or more reinforcement layers may be arranged as carrying layers for the cellulose blank structure 2. The reinforcement layer may have a higher tensile strength than the cellulose blank structure 2. This is useful when one or more air-formed layers of the cellulose blank structure 2 have compositions with low tensile strength in order to avoid that the cellulose blank structure 2 will break during the forming of the cellulose products 1. The reinforcement layer with a higher tensile strength acts in this way as a supporting structure for the cellulose blank structure 2. The reinforcement layer may be of a different composition than the cellulose blank structure 2, such as for example a tissue layer containing cellulose fibres, an airlaid structure comprising cellulose fibres, or other suitable layer structures. It is thus not necessary that the reinforcement layer is air-formed. The one or more reinforcement layers may be provided with graphical elements or patterns for enabling aesthetically attractive cellulose products 1.

The cellulose blank structure 2 may further comprise or be arranged in connection to one or more barrier layers giving the cellulose products 1 the ability to hold or withstand liquids, such as for example when the cellulose products 1 are used in contact with beverages, food, and other water-containing substances. The one or more barrier layers may be of a different composition than the rest of the cellulose blank structure 2, such as for example a tissue barrier structure or a plastic film structure. The cellulose blank structure 2 may further comprise additives for achieving desired properties of the cellulose products 1. The one or more barrier layers may also be applied to the outside of the cellulose products 1, and the one or more barrier layers may be provided with graphical elements or patterns for enabling aesthetically attractive cellulose products 1.

The one or more air-formed layers of the cellulose blank structure 2 are fluffy and airy structures, where the cellulose fibres CF forming the structures are arranged relatively loosely in relation to each other. The fluffy cellulose blank structures 2 are used for an efficient forming of the cellulose products 1, allowing the cellulose fibres CF to form the cellulose products 1 in an efficient way during the forming process.

The shaping unit S is configured for shaping the cellulose blank structure 2 air-formed from the cellulose fibres CF into a shaped cellulose blank structure 2_{S}. This shaping of the cellulose blank structure 2 in the shaping unit S is enabling efficient transportation of the cellulose blank structure 2 and forming of the cellulose products 1 in the pre-forming mould M1 and the forming mould M2. As understood from FIG. 3, the cellulose blank structure 2 is shaped into the shaped cellulose blank structure 2_{S} upstream the pre-forming mould M1 and the forming mould M2. In the shaping unit S, the cellulose blank structure 2 is shaped into the shaped cellulose blank structure 2_{S} having a tube-like configuration with an inner surface and an outer surface. The cellulose blank structure 2 comprising the cellulose fibres CF is provided to the product forming unit U in a flat shape, or essentially flat shape as indicated in FIG. 3.

The cellulose blank structure 2 is as shown in FIG. 3 transported to the feeding unit F for further transportation of the cellulose blank structure 2 to the shaping unit S and the forming moulds, and in the illustrated embodiment, the feeding unit F comprises a pair of feeding rollers. The feeding unit F is configured for feeding the shaped cellulose blank structure 2_{S} around the pressure lance 5 and flexible membrane 6 to the pre-forming mould M1 and the forming mould M2. The feeding unit is further arranged to stop the feeding of the shaped cellulose blank structure 2_{S} upon forming in the respective forming moulds. It should however be understood that the feeding unit F may have any suitable configuration, such as conveyor belts or other transporting means. The feeding unit F may further be arranged with non-illustrated feeding rollers, feeding belts, or other transportation means arranged in connection to the pre-forming mould M1 and/or the forming mould M2, for an efficient feeding, pulling and/or pushing of the shaped cellulose blank structure 2_{S} through the product forming unit U. The feeding rollers, feeding belts, or other transportation means, may be arranged before and/or after the pre-forming mould M1 and/or the forming mould M2, and provided with suitable gripping means for feeding, pulling and/or pushing the shaped cellulose blank structure 2_{S}. The construction and layout of the feeding unit F may for example vary depending on the design of the product forming unit U, the size and design of the cellulose products 1 produced, and materials used in the cellulose blank structure 2.

In the embodiment illustrated in FIG. 3, the shaping unit S comprises a plurality of deflecting rollers 8 for shaping the air-formed cellulose blank structure 2 into the shaped cellulose blank structure 2_{S}. As exemplified, the deflecting rollers 8 are shaping the cellulose blank structure 2 upon feeding in a longitudinal direction D_{LO} of the product forming unit U through a deflecting movement of the cellulose blank structure 2 enabled by the deflecting rollers 8. When passing through the shaping unit S, the cellulose blank structure 2 is shaped into the shaped cellulose blank structure 2_{S} with the tube-like configuration by the deflecting rollers 8, as understood from FIG. 3. The formed shaped cellulose blank structure 2_{S} is suitably having an overlapping tube-like configuration O that is securing that the shaped cellulose blank structure 2_{S} is formed without any gaps or open passages. When being shaped, opposite side edges of the cellulose blank structure 2 are overlapping each other in the shaped cellulose blank structure 2_{S}. The shaping unit S may in other non-illustrated embodiments be arranged with deflecting plates or similar arrangements instead of the deflecting rollers 8, or alternatively arranged with a combination of deflecting plates and deflecting rollers.

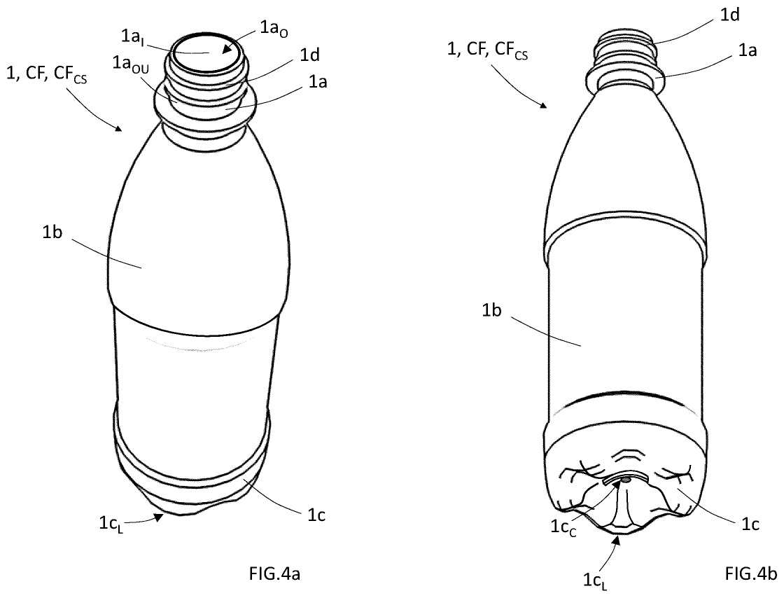

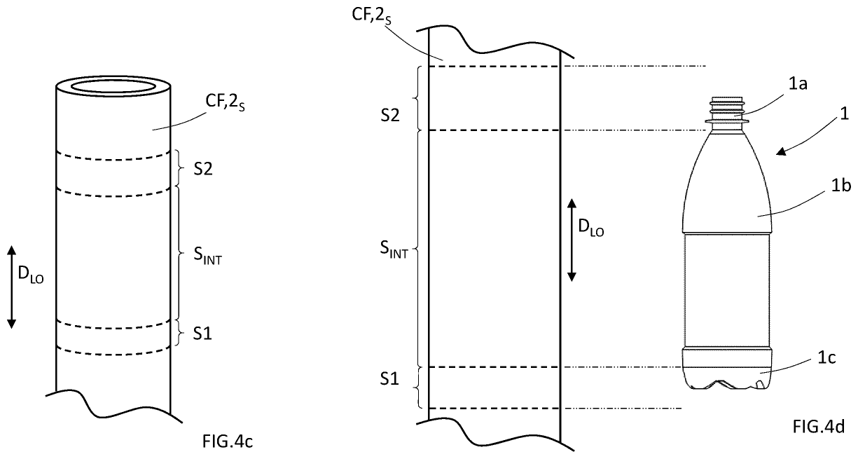

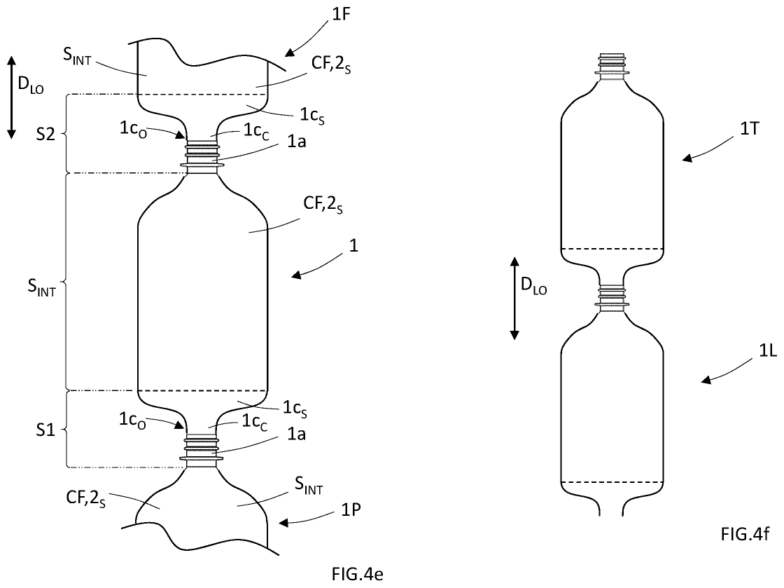

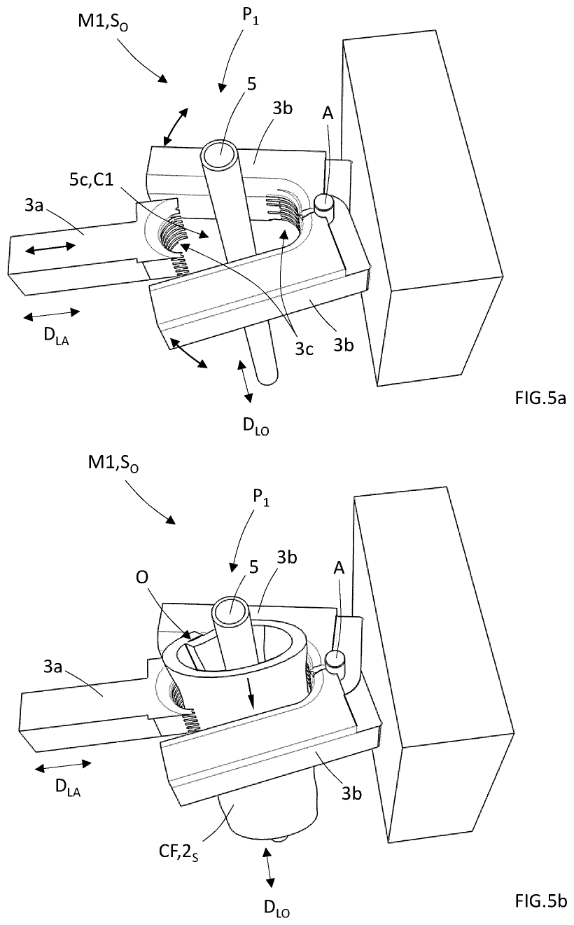

A dry-formed cellulose product 1 is schematically shown in FIGS. 4a-b. The cellulose product 1 has a longitudinal extension and comprises a neck portion 1a, a closed bottom portion 1c, and an upper portion 1b arranged in the longitudinal direction between the closed bottom portion 1c and the neck portion 1a. When the cellulose product 1 is arranged in the position shown in FIGS. 4a-b, the upper portion 1b is arranged above the closed bottom portion 1c and the neck portion 1a is arranged above the upper portion 1b. In the following, when it is referred to relative positions of the cellulose product 1 when formed or upon forming, expressions such as above are referring to the positioning of the cellulose product 1 illustrated in FIGS. 4a-b, where the cellulose product 1 is arranged for being placed on a surface in a standing position. The upper portion 1b is arranged in fluid communication with the neck portion 1a, and the neck portion 1a is provided with a flow opening 1a_{O}. The neck portion 1a suitably comprises a threaded section 1d for a secure attachment of a non-illustrated threaded cap.

The dry-formed cellulose product 1 shown in FIGS. 4a-b is arranged as a rigid self-sustained cellulose-based bottle having a three-dimensional compressed fibre structure CF_{CS}, comprising compressed air-formed cellulose fibres CF. The neck portion 1a is in a conventional manner arranged with a through channel for transportation of liquids out from the cellulose product 1 via the flow opening 1a_{O}. The closed bottom portion 1c and the upper portion 1b are together forming a liquid holding space, and the upper portion 1b has a hollow configuration.

As will be further described below, the closed bottom portion 1c comprises a centrally arranged closed collar section 1c_{C} of compressed cellulose fibres CF. The centrally closed collar section 1c_{C} is resulting from the bottle forming process in the pre-forming mould M1 and the forming mould M2 and is providing a rigid bottom structure of the cellulose product 1.

The closed collar section 1c_{C} is positioned at a distance above one or more lowest parts 1c_{L} of the closed bottom portion 1c in the longitudinal direction, as understood from for example FIG. 4b. With this configuration, the one or more lowest parts 1c_{L} of the cellulose product 1 can be used for providing a stable bottom structure of the cellulose product 1, where the bottom structure suitably has an inwardly curved surface configuration. The cellulose product 1 has with this construction a high stability when placed on an object surface, such as for example a table surface or other surface. In the embodiment illustrated in FIG. 4b, the cellulose product 1 is arranged with several lowest parts 1c_{L} for a high stability.

In the embodiment shown in FIG. 3, the cellulose product 1 is formed in different forming steps in the pre-forming mould M1 and the forming mould M2. The pre-forming mould M1 is used for forming the neck portion 1a of the cellulose product 1, and partly forming the closed bottom portion 1c of the cellulose product 1 into a semi-closed bottom portion 1c_{S}. The forming mould M2 is used for forming the upper portion 1b of the cellulose product 1 and forming the closed bottom portion 1c from the semi-closed bottom portion 1c_{S}. Upon forming of the semi-closed bottom portion 1c_{S} in the pre-forming mould M1, a collar section 1c_{C} of the semi-closed bottom portion 1c_{S} is established by forces acting on the shaped cellulose blank structure 2_{S}.

Each individual cellulose product 1 is formed in main sequential forming steps in the pre-forming mould M1 and the forming mould M2. The semi-closed bottom portion 1c_{S} is formed in a first sequential forming step in the pre-forming mould M1, the neck portion 1a is formed in a second sequential forming step in the pre-forming mould M1, and the upper portion 1b together with the closed bottom portion 1c is formed in a third sequential forming step in the forming mould M2, as will be further described below.

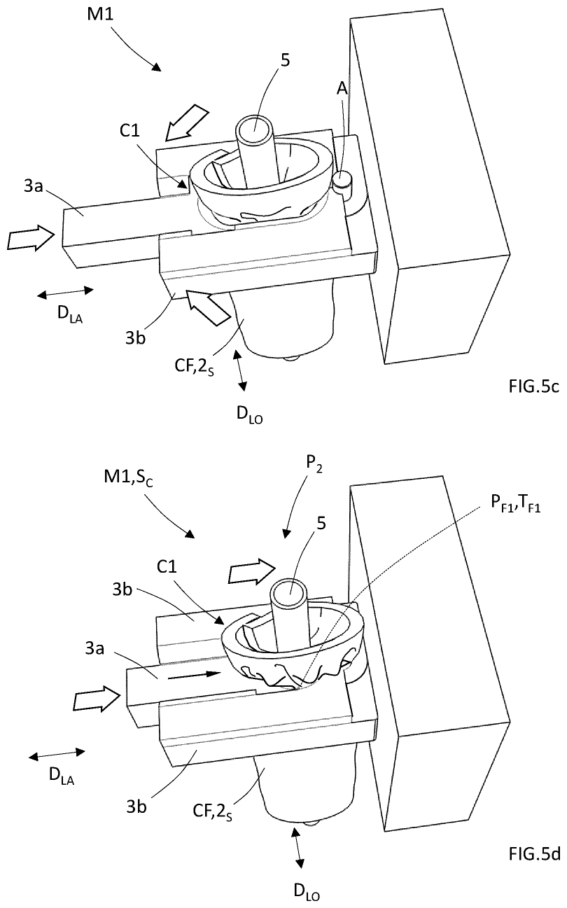

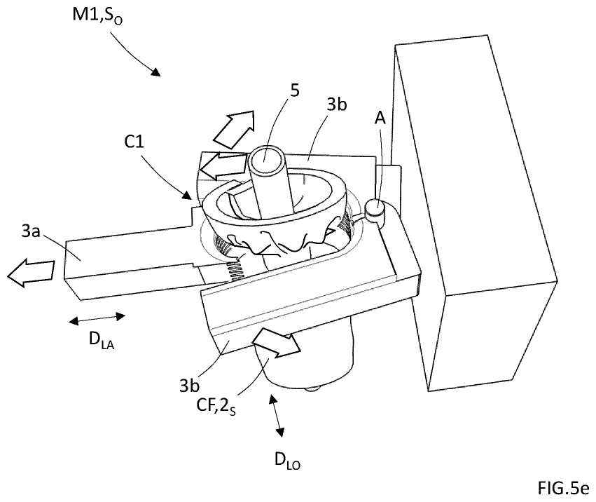

The pre-forming mould M1 has a dual configuration for simultaneous forming of a neck portion 1a and a semi-closed bottom portion 1c_{S}, and as understood from the illustrated configuration of the product forming unit U shown in for example FIGS. 5a-e, the simultaneous forming in the pre-forming mould M1 is resulting in the forming of a neck portion 1a and a semi-closed bottom portion 1c_{S} of different products. In this way, the pre-forming mould M1 is configured for forming a neck portion 1a of a leading cellulose product 1L simultaneously with forming a semi-closed bottom portion 1c_{S} of a directly following trailing cellulose product 1T from the shaped cellulose blank structure 2_{S}, as will be further described below.

The pre-forming mould M1 is schematically illustrated in FIGS. 5a-e. In FIGS. 5a-e, the shaped cellulose blank structure 2_{S} is sectioned for illustrative purposes, where only a part of the shaped cellulose blank structure 2_{S} is shown. The pre-forming mould M1 comprises an outer mould part 3a and an inner mould part 3b arranged around a forming section 5c of the pressure lance 5. The outer mould part 3a is movably arranged relative to the pressure lance 5 as indicated with the arrow in FIG. 5a. The outer mould part 3a is suitably displaceable in reciprocating linear movements towards and away from the pressure lance 5. The inner mould part 3b comprises clamping arm sections pivotably arranged relative to each other around a pivoting axis A, as indicated with arrows in FIG. 5a. The inner mould part 3b is extending partly around the pressure lance 5. The inner mould part 3a is suitably displaceable in pivoting movements around the pivoting axis A towards and away from the pressure lance 5. In FIG. 5a, the pre-forming mould M1 is arranged in an open state S_{O}, where the outer mould part 3a and the inner mould part 3b have been displaced away from the pressure lance 5, allowing the shaped cellulose blank structure 2_{S} to be fed around the pressure lance 5 and through the mould parts, as shown in FIG. 5b.

The pre-forming mould M1 comprises a forming cavity C1 formed between the outer mould part 3a, the inner mould part 3b, and the forming section 5c of the pressure lance 5, as shown in FIGS. 5a-e. The forming section 5c of the pressure lance 5 is movably arranged relative to the outer mould part 3a and the inner mould part 3b between a first position P₁ in an open state S_{O} of the pre-forming mould M1 and a second position P₂ in a closed state S_{C} of the pre-forming mould M1.

The feeding unit F is feeding the shaped cellulose blank structure 2_{S} around the pressure lance 5 and through the outer mould part 3a and the inner mould part 3b when the pre-forming mould M1 is arranged in the open state S_{O}. In the open state S_{O}, the forming section 5c of the pressure lance 5 is in the first position P₁, as shown in FIG. 5a. When the shaped cellulose blank structure 2_{S} is arranged in the position shown in FIG. 5b, where the shaped cellulose blank structure 2_{S} is positioned between the pressure lance 5, the outer mould part 3a, and the inner mould part 3b, the mould parts may be displaced towards the forming section 5c of the pressure lance 5, as indicated with arrows in FIG. 5c. At the same time, the forming section 5c of the pressure lance 5c is moved from the first position P₁ towards the second position P₂. Suitably, the inner mould part 3b is pivoted towards the pressure lance 5 in a movement faster than the displacement of the outer mould part 3a for an efficient forming process. When the inner mould part 3b is closed, as shown in FIG. 5c, the outer mould part 3a may be further pushed towards the pressure lance 5 with a suitable pushing force to a closed state S_{C} of the pre-forming mould M1, as indicated with the arrow in FIG. 5d. In the closed state S_{C}, the forming section 5c of the pressure lance 5 is arranged in the second position P₂ of the pre-forming mould M1. When closed, the outer mould part 3a and the inner mould part 3b are pressing the shaped cellulose blank structure 2_{S} radially against the forming section 5c of the pressure lance 5 for simultaneously forming the neck portion 1a and the semi-closed bottom portion 1c_{S} in the forming cavity C1. During the pressing operation, a forming pressure P_{F1} and a forming temperature T_{F1} are at least applied onto the part of the shaped cellulose blank structure 2_{S} used for forming the neck portion 1a in the forming cavity C1. After the forming operation the pre-forming mould M1 is returned to the open state S_{O}, as shown in FIG. 5e. In FIG. 4e, the formed neck portion 1a and the semi-closed bottom portion 1c_{S} with the collar section 1c_{C} are schematically shown, where the collar section 1c_{C} is the most narrow portion of the semi-closed bottom portion 1c_{S} that is transitioning towards the neck portion 1a. As understood from the figure, the collar section 1c_{C} has a collar opening 1c_{O} that is corresponding to the flow opening 1a_{O} of the neck portion 1a.

The outer mould part 3a and the inner mould part 3b of the pre-forming mould M1 suitably comprises a thread forming section 3c, as shown in for example FIG. 5a. The thread forming section 3c is forming the threaded section 1d of the neck portion 1a upon forming of the neck portion 1a in the pre-forming mould M1. The thread forming section 3c is arranged with a threaded pattern for efficient forming of threads of the threaded section 1d on the outside surface of the neck portion 1a in the pre-forming mould, as understood from the figures.

The applied forming pressure P_{F1} in the pre-forming mould M1 is suitably in the range of 1-1000 MPa, preferably 4-200 MPa, and the applied forming temperature T_{F1} is suitably in the range of 60-300 °C, preferably 100-200 °C.

The outer mould part 3a and the inner mould part 3b of the pre-forming mould M1 are suitably arranged as stiff mould parts. With stiff mould parts is meant that the mould parts are made of a stiff material with limited deformation capabilities, such as for example steel, aluminium, composite materials or a combination of different materials. The forming section 5c of the pressure lance 5 extending through the pre-forming mould M1 is suitably made of a stiff material with limited deformation capabilities, such as for example steel, aluminium, composite materials or a combination of different materials. The forming section 5c of the pressure lance 6 may be stiffer than the other parts of the pressure lance 6 to withstand the high forming pressure in the pre-forming mould M1. In one embodiment, the forming section 5c of the pressure lance 5 extending through the pre-forming mould M1 is reinforced with an outer structural piece of material surrounding the pressure lance 5, establishing a strong structural part around the pressure lance 5.

The mould part M1 may further comprise a heating unit. The heating unit is configured for applying the forming temperature T_{F1} onto the shaped cellulose blank structure 2_{S} in the forming cavity C1 during the forming operation in the pre-forming mould M1. The heating unit may have any suitable configuration. The heating unit may be integrated in or cast into the outer mould part 3a and the inner mould part 3b, and suitable heating devices are e.g. electrical heaters, such as resistor elements, or fluid heaters. Other suitable heat sources may also be used.

The shaped cellulose blank structure 2_{S} may in other non-illustrated embodiments be pre-shaped into an hourglass-shape before being inserted into the pre-forming mould M1 for facilitating the forming operation in the pre-forming mould M1. Suitable shaping elements may be used for delimiting the radial extension of sections of the pre-shaped cellulose blank structure 2_{S} for enabling the hourglass shape. The shaping elements may for example be arranged as a snare structure or snare-like element arranged around the shaped cellulose blank structure 2_{S} upstream the pre-forming mould M1, where the snare structure or snare-like element upon constriction is delimiting the radial extension of a section of the shaped cellulose blank structure 2_{S}. After pre-shaping, the snare structure or snare-like element is returning to a non-constricted state for feeding of the pre-shaped section of the shaped cellulose blank structure 2_{S} to the pre-forming mould M1.

As described above, each individual cellulose product 1 is formed in sequential steps in the pre-forming mould M1 and the forming mould M2. When the semi-closed bottom portion 1_{S} and the neck portion 1a for an individual product 1 have been formed in the first sequential and second sequential forming steps in the pre-forming mould M1, the semi-closed bottom portion 1c_{S} and the neck portion 1a together with an intermediate section S_{INT} of the shaped cellulose blank structure 2_{S} between the formed semi-closed bottom portion 1c_{S} and the neck portion 1a is transported to the forming mould M2. The upper portion 1b together with the closed bottom portion is formed in a third sequential forming step in the forming mould M2, as will be further described below.

A shaped cellulose blank structure 2_{S} is schematically shown in FIG. 4c. The shaped cellulose blank structure 2_{S} is during the forming operation transported through the pre-forming mould M1 and thereafter through the forming mould M2. The shaped cellulose blank structure 2_{S} is for illustrative purposes to better understand the bottle forming process schematically divided into a first section S1, an intermediate section S_{INT}, and a second section S2, as shown in FIGS. 4c-d, where the different sections are used for forming different parts of the cellulose product 1. In the first sequential forming step, the first section S1 is fed to the pre-forming mould M1. The first section S1 of the shaped cellulose blank structure 2_{S} is used for forming the semi-closed portion 1c_{S} of the cellulose product 1 simultaneously with forming the neck portion 1a of a directly preceding cellulose product 1P, as understood from FIG. 4e. Thereafter, in the second sequential forming step, the following second section S2 arranged at a distance from the first section S1 is fed to the pre-forming mould M1. The second section S2 of the shaped cellulose blank structure 2S is used for forming the neck portion 1a of the cellulose product 1 simultaneously with forming the semi-closed portion 1c_{S} of a directly following cellulose product 1F, as understood from FIG. 4e. The part of the shaped cellulose blank structure 2_{S} shown in FIG. 4e is illustrating the configuration after the two sequential forming steps of forming operations in the pre-forming mould M1. As understood from FIG. 4e, the intermediate section S_{INT} has not yet been shaped or formed in the forming mould M2 after the two sequential steps of forming operations in the pre-forming mould M1. As described above, upon forming of the semi-closed bottom portion 1c_{S} in the pre-forming mould M1, the collar section 1c_{C} of the semi-closed bottom portion 1c_{S} is established by forces acting on the shaped cellulose blank structure 2_{S}. The collar section 1c_{C} is defined as the most narrow portion of the semi-closed bottom portion 1c_{S} that is transitioning towards the neck portion 1a, as for example shown in FIG. 4e.

A row of dry-formed cellulose products 1 are produced after each other from the shaped cellulose blank structure 2_{S}, as understood from for example FIG. 4e. As indicated in FIG. 4e, consecutive cellulose products can be formed from the shaped cellulose blank structure 2_{S}, which in the figure has been pre-shaped in the pre-forming mould M1 as described above. In FIG. 4f, the relationship between following cellulose products is illustrated, where a leading cellulose product 1L is directly followed by a trailing cellulose product 1T. The expressions leading and trailing are in this respect referring to the feeding direction through the forming moulds, and a leading cellulose product 1L is thus formed before a trailing cellulose product 1T in the pre-forming mould M1 and forming mould M2. If referring to FIGS. 4e-f, the preceding cellulose product 1P illustrated in FIG. 4e is a leading cellulose product 1L relative to the directly succeeding cellulose product 1, and the cellulose product 1 is a trailing product relative to the preceding cellulose product 1P. If again referring to FIGS. 4e-f, the cellulose product 1 illustrated in FIG. 4e is a leading cellulose product 1L relative to the directly succeeding following cellulose product 1F, and the following cellulose product 1F is a trailing product relative to the cellulose product 1.

The expressions above will be used in the following to define relationships in the cellulose product forming flow.

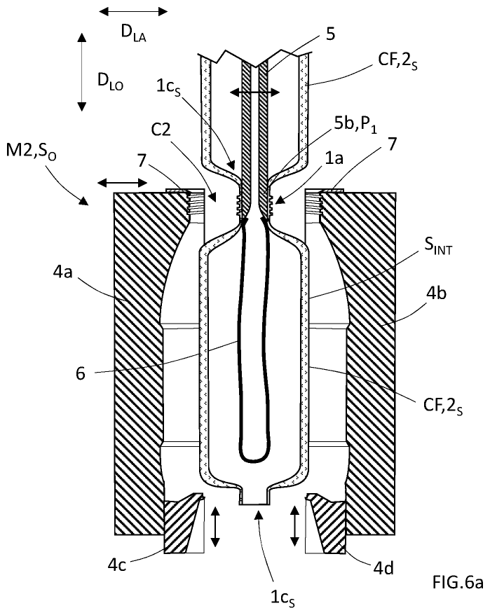

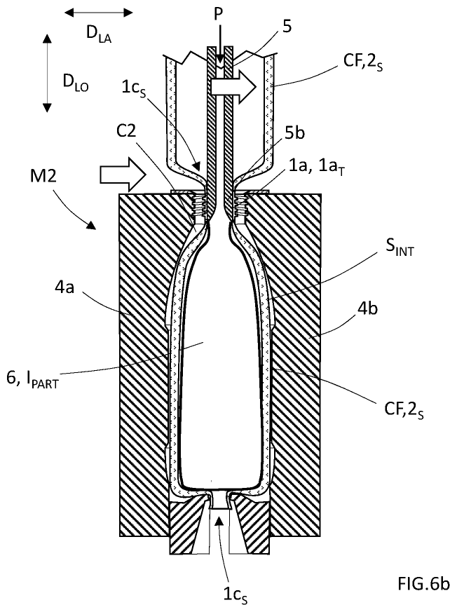

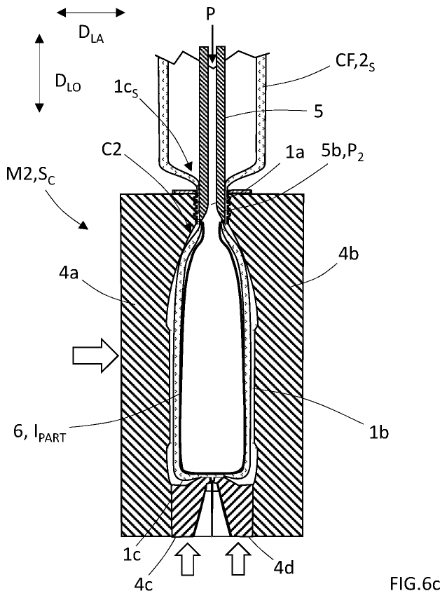

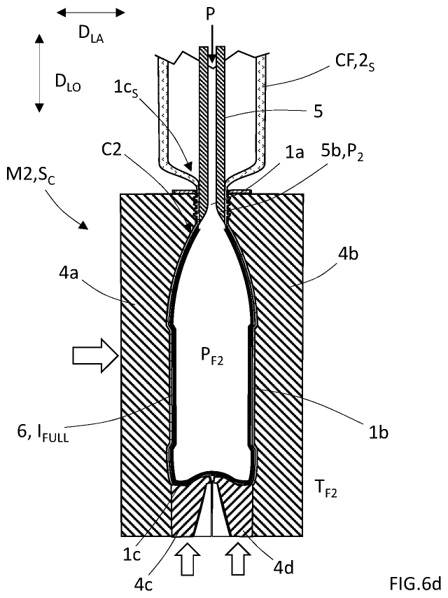

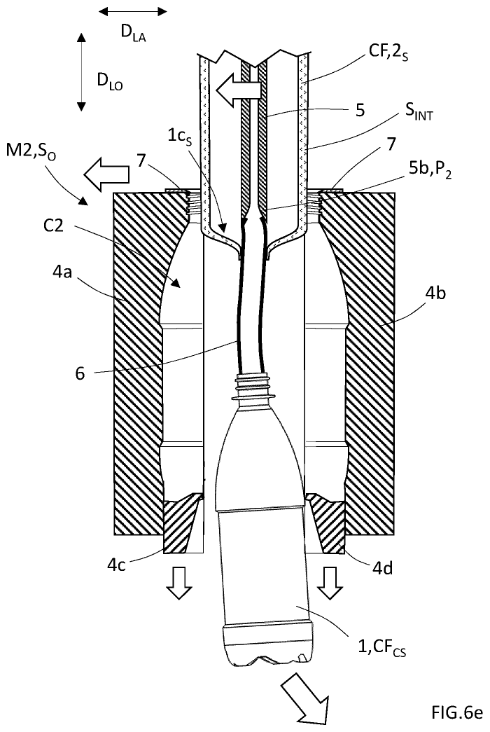

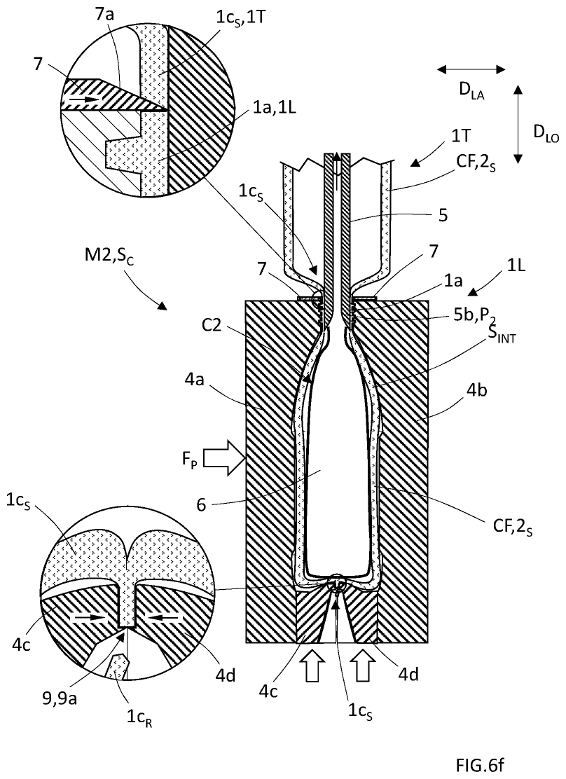

The forming mould M2 is schematically illustrated in FIGS. 6a-f. The forming mould M2 comprises a first mould part 4a, a second mould part 4b, a first lower mould part 4c, and a second lower mould part 4d, forming a forming cavity C2. A flexible membrane 6 is arranged in the forming cavity C2, and the flexible membrane 6 is connected to and arranged in fluid communication with the pressure lance 5. The pressure lance 5 is suitably extending to or partly into the forming cavity C2. A pressure medium P is used for inflating the flexible membrane 6 when dry-forming the cellulose products 1 in the forming mould M2.

The first mould part 4a is movably arranged relative to the second mould part 4b and relative to the flexible membrane 6 in a lateral direction D_{LA}, as indicated with an arrow in FIG. 6a. The second mould part 4b is arranged as a stationary mould part. The first lower mould part 4c is movably arranged relative to the second lower mould part 4d in the lateral direction D_{LA}, and the first lower mould part 4c and the second lower mould part 4d are movably arranged in a longitudinal direction D_{LO} towards the flexible membrane 6, as indicated with the double arrows in FIG. 6a. The second end 5b of the pressure lance 5 is movably arranged in the lateral direction D_{LA} relative to the first mould part 4a and the second mould part 4b between a first position P₁ in the open state S_{O} and a second position P₂ in the closed state S_{C}.

The first mould part 4a is suitably displaceable in the lateral direction D_{LA} in reciprocating linear movements towards and away from the second mould part 4b and the flexible membrane 6. The first lower mould part 4c is suitably displaceable in the lateral direction D_{LA} in reciprocating linear movements towards and away from the second lower mould part 4d. The first lower mould part 4c is suitably displaceable in the longitudinal direction D_{LO} in reciprocating linear movements towards and away from the flexible membrane 6. The second lower mould part 4d is suitably displaceable in the longitudinal direction D_{LO} in reciprocating linear movements towards and away from the flexible membrane 6.

When closing the forming mould M2, the first mould part 4a is moved towards the second mould part 4b together with moving the first lower mould part 4c towards the second lower mould part 4d in the lateral direction D_{LA}. The second end 5b of the pressure lance 5 is moved in the lateral direction D_{LA} towards the second mould part 4b from the first position P₁ in the open state S_{O} to the second position P₂. The first lower mould part 4c and the second lower mould part 4d are moved relative to the first mould part 4a and second mould part 4b respectively in the longitudinal direction D_{LO} towards the flexible membrane 6. The second end 5b of the pressure lance 5 is suitably displaced as described above by a pivoting or sliding movement.

When opening the forming mould M2, the first mould part 4a is moved away from the second mould part 4b together with moving the first lower mould parts 4c away from the second lower mould part 4d in the lateral direction D_{LA}. The second end 5b of the pressure lance 5 is moved in the lateral direction D_{LA} away from the second mould part 4b from the second position P₂ in the closed state to the first position P₁. The first lower mould part 4c and the second lower mould part 4d are moved relative to the respective first mould part 4a and second mould part 4b in the longitudinal direction D_{LO} away from the flexible membrane 6. The second end 5b of the pressure lance 5 is suitably displaced by a pivoting or sliding movement of the pressure lance 5.

In FIG. 6a, the forming mould M2 is arranged in the open state S_{O}, where the first mould part 4a has been displaced in the lateral direction D_{LA} away from the second mould part 4b and away from the flexible membrane 6. The first lower mould part 4c has been displaced away from the second lower mould part 4d and away from the flexible membrane 6 in the lateral direction D_{LA}. The first lower mould part 4c and the second lower mould part 4d have been displaced away from the flexible membrane 6 in the longitudinal direction D_{LO}. In the open state, the second end 5b of the pressure lance 5 is arranged in the first position P₁. In the open state S_{O}, the shaped cellulose blank structure 2_{S} is fed around the flexible membrane 6 and received between the mould parts, as shown in FIG. 6a.

The forming mould M2 is forming the upper portion 1b of the cellulose product 1 from the intermediate section S_{INT}, and the closed bottom portion 1c of the cellulose product 1 from the semi-closed bottom portion 1cs in the forming cavity C2. The feeding unit F is feeding the formed semi-closed bottom portion 1c_{S}, the intermediate section S_{INT}, and the formed neck portion 1a around the pressure lance 5 from the pre-forming mould M1 towards the forming mould M2 when the pre-forming mould M1 and the forming mould M2 are arranged in the open states S_{O}. The feeding unit F is thus feeding the shaped cellulose blank structure 2_{S} around the pressure lance 5 and flexible membrane 6 into the forming mould M2 for arranging the cellulose fibres CF into the open forming mould M2. The feeding unit F is in this way feeding the formed semi-closed bottom portion 1c_{S} and the intermediate section S_{INT} of the shaped cellulose blank structure 2_{S} between the formed semi-closed bottom portion 1c_{S} and a directly following formed trailing neck portion 1a from the pre-forming mould M1 to the forming mould M2, as shown in FIG. 6a. The feeding of the shaped cellulose blank structure 2_{S} is stopped when positioned in the open forming mould M2.

When the shaped cellulose blank structure 2_{S} with the semi-closed bottom portion 1c_{S} and the intermediate section S_{INT} is arranged in the position shown in FIG. 6a, and thus positioned between the first mould part 4a and the second mould part 4b, and between the first lower mould part 4c and the second lower mould part 4d, with the flexible membrane 6 arranged inside the shaped cellulose blank structure 2_{S}, the forming mould M2 is closed around the shaped cellulose blank structure 2s.

When closing of the forming mould M2, the first mould part 4a is moved towards the second mould part 4b together with moving the first lower mould part 4c towards the second lower mould part 4d in the lateral direction D_{LA}. The second end 5b of the pressure lance 5 is moved in the lateral direction D_{LA} towards the second mould part 4b from the first position P₁ in the open state S_{O} to the second position P₂. The first lower mould part 4c and the second lower mould part 4d are moved relative to the first mould part 4a and second mould part 4b respectively in the longitudinal direction D_{LO} towards the flexible membrane 6. The mould parts are thus displaced for arranging the forming mould M2 into the closed state S_{C}, as shown in FIGS. 6c-d, and the movements of the mould parts towards the closed state S_{C} are indicated with arrows in FIGS. 6b-c. Upon displacement of the first mould part 4a in the lateral direction D_{LA}, the first lower mould part 4c in the lateral direction D_{LA}, and the first lower mould part 4c and the second lower mould part 4d in the longitudinal direction D_{LO}, the mould parts are pushing the semi-closed bottom portion 1c_{S} towards a closed configuration, as shown in FIGS. 6b-c and illustrated more in detail in FIG. 6f. The first lower mould part 4c and the second lower mould part 4d are gripping the collar section 1c_{C} of the semi-closed bottom portion 1c_{S} when the first lower mould part 4c is moved, for an efficient forming process. The semi-closed bottom portion 1c_{S} is in this way pushed towards a closed configuration upon closing the first lower mould part 4c and second lower mould part 4d around the semi-closed bottom portion 1c_{S}, and the collar opening 1c_{O} of the semi-closed bottom portion 1c_{S} is closed by the forces exerted by the first lower mould part 4c and second lower mould part 4d. In FIG. 6d, the forming mould M2 is arranged in the closed state S_{C}, in which the shaped cellulose blank structure 2_{S} can be dry-formed into the cellulose product 1. In the closed state, the second end 5b of the pressure lance 5 has been moved in the lateral direction D_{LA} to the second position P₂. To secure the closed state S_{C} of the forming mould M2 during the forming process, the mould parts may be pushed with suitable pushing forces.

Upon movement of the mould parts in the lateral direction D_{LA} and the longitudinal direction D_{LO}, the flexible membrane 6 may be partly inflated with the pressure medium P into a partly inflated state I_{PART}, as shown in FIGS. 6b-c. In the partly inflated state I_{PART}, the partly inflated flexible membrane 6 is pushing the cellulose fibres CF towards the mould parts and/or the mould parts are pushing the cellulose fibres CF towards the partly inflated flexible membrane 6 for an efficient distribution of the cellulose fibres in the forming cavity C2. The partly inflated flexible membrane 6 is thus enabling an efficient distribution of the cellulose fibres CF in the forming cavity C2 upon movement of the mould parts, and it should be understood that the flexible membrane 6 may be partly inflated with the pressure medium P before movement or upon movement of the mould parts. During the closing of the forming mould M2, the cellulose fibres CF are pushed towards a closed bottom configuration by means of the first lower mould part 4c and second lower mould part 4d when moved in the lateral direction D_{LA} and the longitudinal direction D_{LO}, for pre-shaping the closed bottom portion 1c by the forces exerted by the first lower mould part 4c and second lower mould part 4d, as shown in FIGS. 6b-c.

When the forming mould M2 is arranged in the closed state S_{C}, the flexible membrane 6 is inflated with the pressure medium P into a fully inflated state I_{FULL} for establishing a forming pressure P_{F2} for an efficient dry-forming operation of the cellulose product 1 in the forming mould M2, as shown in FIG. 6d. In the closed state S_{C}, the mould parts together with the flexible membrane 6 are forming the closed bottom portion 1c and the upper portion 1b of the cellulose product 1 by inflating the flexible membrane 6 towards the mould parts. The flexible membrane 6 is inflated with the pressure medium P entering from the pressure lance 5, as indicated with the arrow in FIG. 6d. When the forming mould M2 is closed around the semi-closed bottom portion 1c_{S} and the intermediate section S_{INT}, the further closed semi-closed bottom portion 1c_{S} and the intermediate section S_{INT} are pressed against the mould parts by means of the inflated flexible membrane 6 for applying the forming pressure P_{F2} onto the cellulose fibres CF. The flexible membrane 6 is thus inflated with the pressure medium P entering from the pressure lance 5, and the forming pressure P_{F2} is applied onto the intermediate section S_{INT} and the further closed semi-closed bottom portion 1c_{S} by pressing the intermediate section S_{INT} and the further closed semi-closed bottom portion 1c_{S} against the mould parts by means of the inflated flexible membrane 6. A forming temperature T_{F2} is applied onto the further closed semi-closed bottom portion 1c_{S} and the intermediate section S_{INT} in the forming mould M2. In this way the forming pressure P_{F2} and the forming temperature T_{F2} are enabling the dry-forming of the cellulose product 1 with the closed bottom portion 1c and the upper portion 1c into a three-dimensional compressed fibre structure CF_{CS}.

The applied forming pressure P_{F2} in the forming mould M2 is suitably in the range of 1-100 MPa, preferably 4-20 MPa, and the applied forming temperature T_{F2} is suitably in the range of 60-300 °C, preferably 100-200 °C.

After the forming operation, the forming mould M2 is returned to the open state S_{O}, as shown in FIG. 6e, for an easy removal of the cellulose product 1 from the forming mould M2 and for repeating the dry-forming operation. After forming of the cellulose product 1, the flexible membrane 6 is deflated and the forming mould M2 is opened. Upon opening the forming mould M2, the first mould part 4a is moved away from the second mould part 4b in the lateral direction D_{LA}, and the lower mould parts are moved away from each other in the lateral direction D_{LA} and in the longitudinal direction D_{LO} away from the flexible membrane 6, as understood from FIG. 6e. The second end 5b of the pressure lance 5 is moved in the lateral direction D_{LA} away from the second mould part 4b to the first position P₁.

The mould parts of the forming mould M2 are suitably arranged as stiff mould parts. With stiff mould parts is meant that the mould parts are made of a stiff material with limited deformation capabilities, such as for example steel, aluminium, composite materials or a combination of different materials. The second mould part M2 may further comprise a heating unit, as described above.

The bottom of the formed rigid closed bottom portion 1c of the cellulose product 1 formed into a bottle has an inwardly curved surface configuration, as understood from for example FIG. 4b. The closed collar section 1c_{c} of the semi-closed bottom portion 1c_{S} is in this way arranged above the lowermost portions of the cellulose product 1. The inwardly curved surface configuration is enabled by the shape of the first lower mould part 4c, the second lower mould part 4d, and the inflation of the flexible membrane 6 upon forming in the forming mould M2, where the flexible membrane 6 is pushing the semi-closed bottom portion 1c_{S} towards the first lower mould part 4c and second lower mould part 4d. The inwardly curved surface configuration is providing a stable bottom structure of the cellulose product 1. The cellulose product 1 has with this construction a high stability when placed on an object surface, such as for example a table surface or other surface.

The already formed upper portion 1a is as understood from FIGS. 6a-f arranged within the forming mould M2 during the forming operation. It should however be understood that no forming pressure is applied to the upper portion 1a in the forming mould M2 during the forming of the cellulose product 1.

The flexible membrane 6 is made of a material that is allowed to deform when being inflated upon forming of the cellulose products 1 in the forming mould M2. Suitable materials are for elastomeric compositions, such as for example rubber, or other elastomers exhibiting elastic or rubber-like properties. The material used in the flexible membrane 6 suitably withstands high pressure levels from the pressure medium P when being inflated, as well as repeated inflation and deflation cycles.

In other non-illustrated embodiments, the flexible membrane 6 may be made of a liquid impermeable single-use plastic film or other suitable material that is adhering to the cellulose product 1 during the forming process. In this way, the plastic film or other suitable material is forming a liquid barrier inside the formed cellulose product 1. With this configuration, a new flexible membrane 6 is provided for each product forming operation in the forming mould M2.

The pressure medium P is used for establishing the second forming pressure P_{F2} in the forming cavity C2 upon inflating the flexible membrane 6. The pressure medium P used in the forming operation in the forming mould M2 may be a liquid composition or a gas, such as for example oil, water, or air. The product forming unit U comprises a fluid control device D, as described above. In the embodiment described above, where the flexible membrane 6 is made of a single-use plastic film or other suitable material that is adhering to the cellulose product 1 during the forming process, the pressure medium P may be a beverage or other liquid that is pressurizing the flexible membrane 6 when forming the cellulose product 1. In this way, the beverage or other liquid is directly filled into the cellulose product 1 during the forming process.

The product forming unit U may further comprise a cutting device 7 arranged in the first mould part 4a and second mould part 4b, or in connection to the first mould part 4a and second mould part 4b, of the forming mould M2. In the embodiment illustrated in FIGS. 6a-f, the cutting device 7 is arranged in the second mould part M2. The cutting device 7 may be arranged with cutting edges 7a on the first mould part 4a and the second mould part 4b respectively as shown in for example FIG. 6f. The cutting device 7 is cutting off the formed neck portion 1a of a leading cellulose product 1L from the semi-closed bottom portion 1c_{S} of a directly following trailing cellulose product 1T by means of the cutting device 7 upon closing of the forming mould M2 during the forming operation of the cellulose product 1 in the forming mould M2, as shown in FIG. 6f. In FIG. 6f, the forming mould M2 is illustrated in the closed state S_{C} before the full inflation of the flexible membrane 6 with the pressure medium P, and the cutting operation is suitably completed when the second mould part M2 is closed.

According to the embodiment shown in FIGS. 6a-f, the pressure lance 5 extends into the forming mould M2. The cutting device 7 may be arranged to work against and around the pressure lance 5 such that the pressure lance 5 acts as an anvil against which the cutting edges 7a are pressed, and the neck portion 1a is in this way separated from the semi-closed bottom portion 1c_{S} accordingly. Here, the pressure lance 5 may comprise a reinforced portion that can withstand the pressure from the cutting edge. The reinforced portion can be arranged as a thicker material portion of the pressure lance 5 and/or can be made from a different material than adjacent portions of the pressure lance 5. As an alternative, the entire pressure lance 5 is made from a suitable material than can withstand pressure, both in the pre-forming mould M1 and the forming mould M2. The reinforced portion can alternatively be arranged as a separate piece of material arranged around the pressure lance 5.

The product forming unit U may further comprise an auxiliary cutting device 9 arranged in the second mould part M2, as illustrated in FIG. 6f. The auxiliary cutting device 9 may be arranged with cutting edges 9a on the first lower mould part 4c and the second lower mould part 4d respectively as indicated in FIG. 6f. The auxiliary cutting device 9 is cutting off residual parts 1_{R} of the closed collar section 1c_{C} of the semi-closed bottom portion 1c_{S} that may extend out from the forming mould M2 when arranged in the closed state S_{C}.

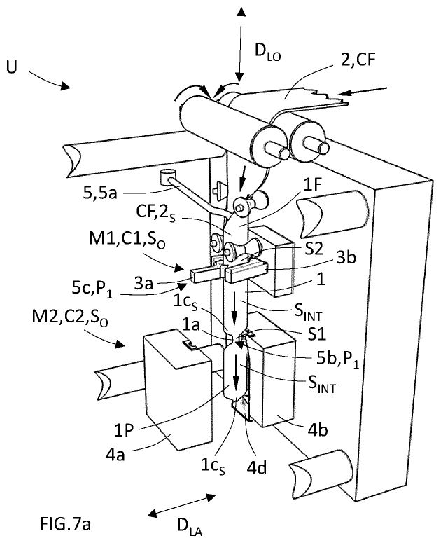

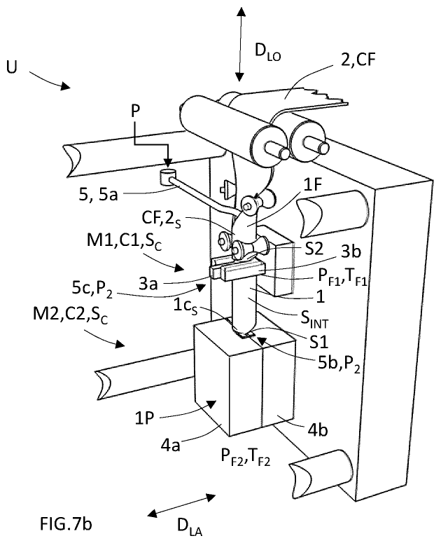

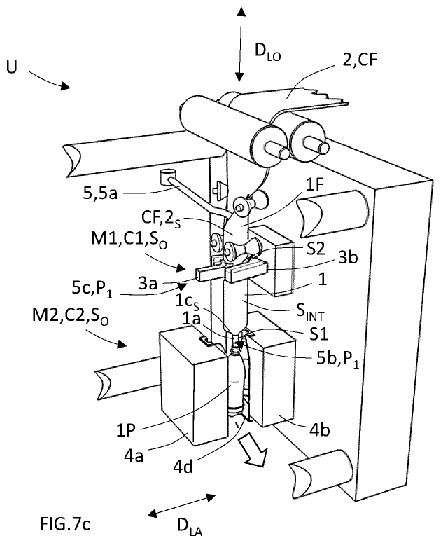

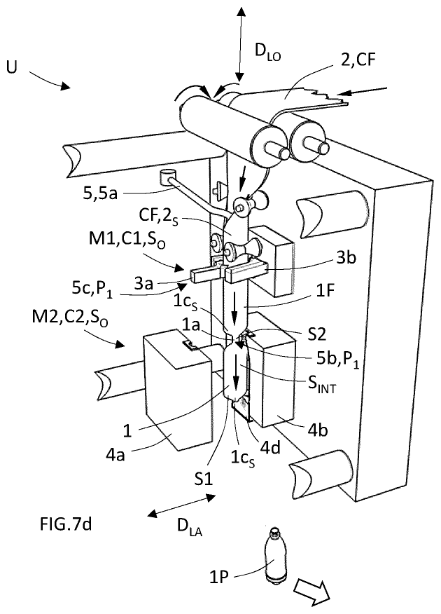

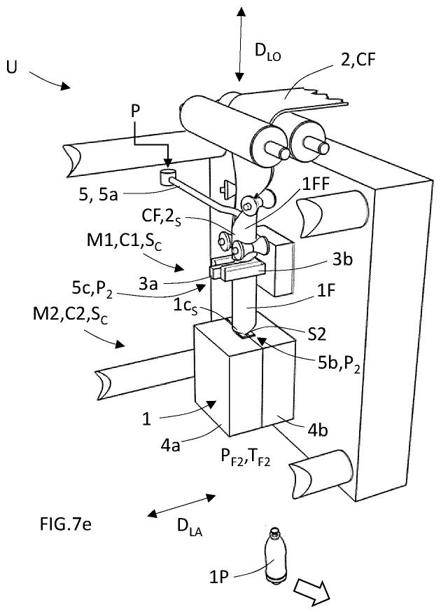

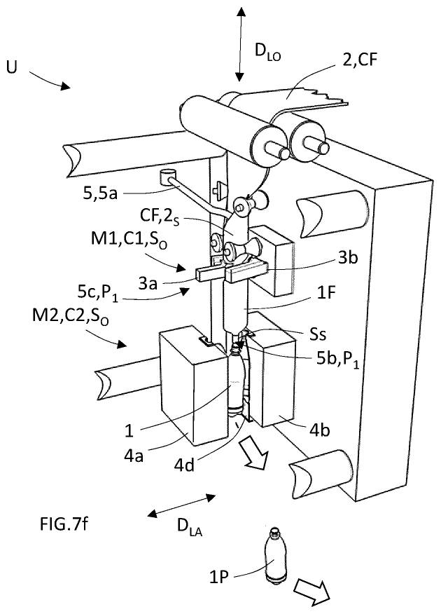

The dry-forming process of the cellulose product 1 shaped as a bottle will be described below in connection to FIGS. 7a-f. Throughout the dry-forming process, the air-formed cellulose blank structure 2 is shaped into a shaped cellulose blank structure 2_{S}, where the shaped cellulose blank structure 2_{S} has a tube-like configuration as described above.

In FIG. 7a, the pre-forming mould M1 is arranged in the open state S_{O} and the forming mould M2 is arranged in the open state S_{O}, with the configurations described above in connection to FIGS. 5a-e and 6a-f. The position in FIG. 7a is illustrating a position after the first sequential forming step in the pre-forming mould M1 and before the second sequential forming step in the pre-forming mould M1 for forming the cellulose product 1. In this position shown in FIG. 7a, the first section S1 of the shaped cellulose blank structure 2_{S} has already been fed to and further transported from the pre-forming mould M1, where the semi-closed bottom portion 1c_{S} of the cellulose product 1 together with the neck portion 1a of the directly preceding cellulose product 1P were simultaneously formed from the first section S1 in the pre-forming mould M1. In the first sequential forming step, the shaped cellulose blank structure 2_{S} was fed around the pressure lance 5 and through the mould parts of the pre-forming mould M1. Thereafter, the feeding of the shaped cellulose blank structure 2_{S} was stopped when the first section S1 of the shaped cellulose blank structure 2_{S} was arranged in a position aligned with the mould parts 3a, 3b. Then, the mould parts 3a, 3b were closed and the first section S1 was pressed against the pressure lance 5 by means of the mould parts 3a, 3b of the pre-forming mould M1 for forming the semi-closed bottom portion 1c_{S} of the cellulose product 1 in the forming cavity C1, and simultaneously forming the neck portion 1a of the directly preceding cellulose product 1P in the forming cavity C1. Upon forming of the semi-closed bottom portion 1c_{S} of the cellulose product 1 in the pre-forming mould M1, the forming pressure P_{F1} and the forming temperature T_{F1} were applied onto at least the part of the first section S1 of the shaped cellulose blank structure 2_{S} used for forming the neck portion 1a of the preceding cellulose product 1P. It should be understood that the forming pressure P_{F1} and the forming temperature T_{F1} also may be applied to at least a part of the first section S1 used for forming the semi-closed bottom portion 1c_{S} for a more structurally rigid formation of the semi-closed bottom portion 1c_{S}. The forming pressure P_{F1} and the forming temperature T_{F1} may for example be applied to the established collar section 1c_{C} of the semi-closed bottom portion 1c_{S}.

In the position shown in FIG. 7a, the following second section S2 of the shaped cellulose blank structure 2_{S} has been fed to the pre-forming mould M1, and at the same time the formed neck portion 1a, the intermediate section S_{INT}, and the semi-closed bottom portion 1c_{S}, of the preceding cellulose product 1P have been fed to the forming mould M2. When opening the mould parts of the pre-forming mould M1, the shaped cellulose blank structure 2_{S} was fed around the pressure lance 5 and through the mould parts. Thereafter, the feeding of the shaped cellulose blank structure 2_{S} was stopped when the second section S2 of the shaped cellulose blank structure 2_{S} is arranged in a position aligned with the mould parts of the pre-forming mould M1, as understood from FIG. 7a.

In FIG. 7b, the pre-forming mould M1 is arranged in the closed state S_{C} and the forming mould M2 is arranged in the closed state S_{C}, with the configurations described above in connection to FIGS. 5a-e and 6a-f. The position of the shaped cellulose blank structure 2_{S} in FIG. 7b, is illustrating a position in the pre-forming mould M1 during the second sequential forming step for forming the neck portion 1a of the cellulose product 1 and the semi-closed bottom portion 1c_{S} of a directly following cellulose product 1F, and a position in the forming mould M2 where the preceding bottle 1P is formed. In this position shown in FIG. 7b, the neck portion 1a of the cellulose product 1 is formed simultaneously with the semi-closed bottom portion 1c_{S} of a directly following cellulose product 1F from the second section S2 in the pre-forming mould M1. After closing of the mould parts of the pre-forming mould M1, the second section S2 is pressed against the forming section 5c of the pressure lance 5 by means of the outer mould part 3a and inner mould part 3b for forming the neck portion 1a of the cellulose product 1 in the forming cavity C1, simultaneously with forming the semi-closed bottom portion 1c_{S} of the directly following cellulose product 1F in the forming cavity C1. Upon forming of the neck portion 1a of the cellulose product 1 in the pre-forming mould M1, the forming pressure P_{F1} and the forming temperature T_{F1} are applied onto at least the part of the second section S2 of the shaped cellulose blank structure 2_{S} used for forming a structurally rigid neck portion 1a of the cellulose product 1. The threaded section 1d of the neck portion 1a is established by the threaded section 3c upon forming of the neck portion 1a in the pre-forming mould M1. It should be understood that the forming pressure P_{F1} and the forming temperature T_{F1} also may be applied to the at least a part of the second section S2 used for forming the semi-closed bottom portion 1c_{S} of the directly following cellulose product 1F for a more structurally rigid formation of the semi-closed bottom portion 1c_{S}. The forming pressure P_{F1} and the forming temperature T_{F1} may for example be applied to the established collar section 1c_{C} of the semi-closed bottom portion 1c_{S} of the directly following cellulose product 1F.

In FIG. 7c, the pre-forming mould M1 and the forming mould M2 have returned to the open states S_{O}, with the configurations described above in connection to FIGS. 5a-e and 6a-f. In FIG. 7c, the formed preceding bottle 1P can be removed from the forming mould M2, as indicated with the arrow. Thereafter, the formed semi-closed bottom portion 1c_{S} of the cellulose product 1 and an intermediate section S_{INT} of the shaped cellulose blank structure 2_{S} between the formed semi-closed bottom portion 1c_{S} of the cellulose product 1 and the formed neck portion 1a of the cellulose product 1 is fed to the forming mould M2, as shown in FIG. 7d.

In the forming mould M2, the upper portion 1b of the cellulose product 1 is formed from the intermediate section S_{INT} and the closed bottom portion 1c of the cellulose product 1 is formed from the semi-closed bottom portion 1c_{S}. To form the cellulose product 1 in the third sequential forming step in the forming mould M2, the semi-closed bottom portion 1c_{S} and the intermediate section S_{INT} is fed around the pressure lance 5 into the forming mould M2, as shown in FIG. 7d. The feeding of the semi-closed bottom portion 1Cs and the intermediate section S_{INT} is stopped when positioned between the open mould parts of the forming mould M2, as shown in FIG. 7d. Thereafter, the forming mould M2 is closed around the semi-closed bottom portion 1c_{S} and the intermediate section S_{INT}, as described above in connection to FIGS. 6a-f.

When the forming mould M2 is closed, the flexible membrane 6 is inflated with the pressure medium P entering from the pressure lance 5, as understood from FIG. 7e. The forming pressure P_{F2} is applied onto the semi-closed bottom portion 1c_{S} and the intermediate section S_{INT}, and the semi-closed bottom portion 1c_{S} and the intermediate section S_{INT} are pressed against the mould parts of the forming mould M2 by means of the inflated flexible membrane 6. The forming temperature T_{F2} is applied onto the semi-closed bottom portion 1c_{S} and the intermediate section S_{INT}, for forming the closed bottom portion 1c and the upper portion 1c of the cellulose product 1 into rigid structures. In this way, the cellulose product 1 is dry-formed with a three-dimensional compressed fibre structure CF_{CS} having a closed bottom portion 1c and an upper portion 1b.

The earlier formed neck portion 1a of the cellulose product 1 is cut off from the semi-closed bottom portion 1c_{S} of the directly following cellulose product 1F by means of the cutting device 7 during the forming of the cellulose product 1 in the forming mould M2. In FIG. 7e, the neck portion 1a of the following bottle 1F is formed in the pre-forming mould M1 together with the semi-closed bottom portion of a further following cellulose product 1FF. After the forming operation, the flexible membrane 6 is deflated and the mould parts are opened for removal of the formed cellulose product 1 from the forming mould M2, as shown in FIG. 7f. A negative pressure may be applied to the flexible membrane 6 for an efficient deflating operation.

The mould parts of the pre-forming mould M1 and mould parts of the forming mould M2 may be simultaneously closed. Alternatively, the mould parts of the pre-forming mould M1 and the mould parts of the forming mould M2 are non-simultaneously closed.

In the embodiment described above, upon closing the forming mould M2, the first lower mould part 4c and the second lower mould part 4d are first moved towards each other in the lateral direction D_{LA} and thereafter in the longitudinal direction D_{LO} towards the flexible membrane 6. In an alternative embodiment, upon closing the forming mould M2, the first lower mould part 4c and the second lower mould part 4d are simultaneously moved towards each other in the lateral direction D_{LA} and in the longitudinal direction D_{LO} towards the flexible membrane 6.

The pressure lance 5, or a part of the pressure lance 5, is suitable movably connected to a holding structure 11, and the pressure lance 5, or a part of the pressure lance 5, can be displaced by movement relative to the holding structure 11.

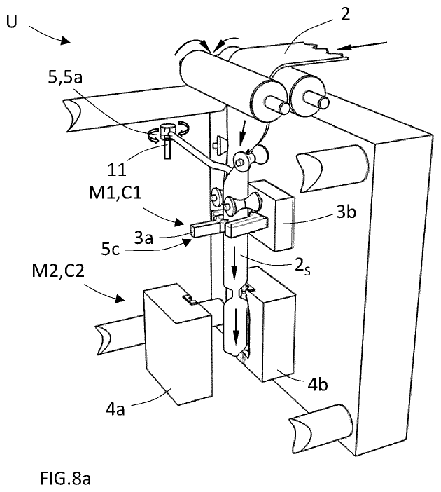

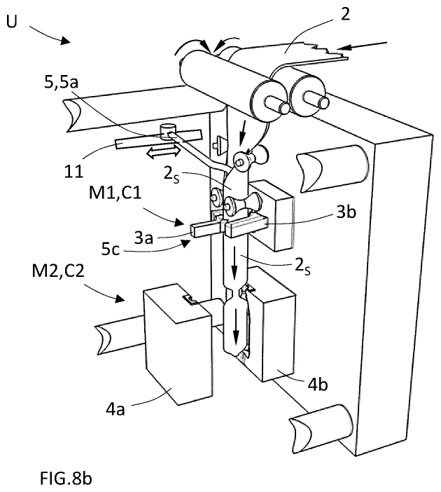

In one embodiment, the first end 5a of the pressure lance 5 is pivotably connected to a holding structure 11, and the pressure lance 5, or a part of the pressure lance 5, can be displaced by a pivoting movement relative to the holding structure 11, as indicated with the arrow in FIG. 8a. The pivoting arrangement may have any suitable configuration or construction. Upon a pivoting movement of the first end 5a relative to the holding structure 11, the second end 5b can be displaced relative to the first mould part 4a and the second mould part 4b. The pivoting movement is enabling the positioning of the second end 5b of the pressure lance 5 between the first position P₁ and the second position P₂.

In one embodiment, the first end 5a of the pressure lance 5 is slidingly connected to a holding structure 11, and the pressure lance 5, or a part of the pressure lance 5, can be displaced by a sliding movement relative to the holding structure 11, as indicated with the arrow in FIG. 8b. The sliding arrangement may have any suitable configuration or construction. Upon a sliding movement of the first end 5a relative to the holding structure 11, the second end 5b can be displaced relative to the first mould part 4a and the second mould part 4b. The sliding movement is enabling the positioning of the second end 5b of the pressure lance 5 between the first position P₁ and the second position P₂.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Cellulose product
1a: Neck portion
1a_{I}: Inner surface
1a_{O}: Flow opening
1a_{OU}: Outer surface
1a_{T}: Trailing neck portion
1b: Upper portion
1c: Closed bottom portion
1c_{C}: Collar section
1c_{L}: Lowest part
1c_{O}: Collar opening
1c_{S}: Semi-closed bottom portion
1d: Threaded section
1F: Following cellulose product
1L: Leading cellulose product
1P: Preceding cellulose product
1T: Trailing cellulose product
2: Cellulose blank structure
2_{S}: Shaped cellulose blank structure
3a: Outer mould part
3b: Inner mould part
3c: Thread forming section
4a: First mould part
4b: Second mould part
4c: First lower mould part
4d: Second lower mould part
5: Pressure lance
5a: First end
5b: Second end
5c: Forming section
6: Flexible membrane
7: Cutting device
8: Deflecting rollers
9: Auxiliary cutting device
10: Transporting device
11: Holding structure
A: Pivoting axis
CF: Cellulose fibres
CF_{CS}: Compressed fibre structure
C1,C2: Forming cavity
D: Fluid control device
D_{LA}: Lateral direction
D_{LO}: Longitudinal direction
F: Feeding unit
I_{FULL}: Fully inflated state
I_{PART}: Partly inflated state
M1: Pre-forming mould
M2: Forming mould
O: Overlapping tube-like configuration
P: Pressure medium
P₁: First position
P₂: Second position
P_{F}: Forming pressure
S: Shaping unit
S1: First section
S2: Second section
S_{C}: Closed state
S_{INT}: Intermediate section
S_{O}: Open state
T_{F}: Forming temperature
U: Product forming unit
X_{LA1}: First lateral distance
X_{LA2}: Second lateral distance

1. A product forming unit for dry-forming a cellulose product from cellulose fibers, wherein the product forming unit comprises a forming mold having a first mold part and a second mold part forming a forming cavity, and a pressure lance comprising a first end and a second end,
wherein the first mold part and/or the second mold part are movably arranged for displacing the forming mold between an open state and a closed state, wherein in the open state the forming mold is configured for receiving the cellulose fibers into the forming cavity, and in the closed state the forming mold is configured for being closed around the cellulose fibers in the forming cavity,
wherein the second end of the pressure lance is extending to or partly into the forming cavity, and wherein the second end is connected to and arranged in fluid communication with a flexible membrane arranged in the forming cavity, wherein the second end of the pressure lance is movably arranged relative to the first mold part and/or the second mold part between a first position in the open state and a second position in the closed state.

2. The product forming unit according to claim 1,
wherein the first mold part is movably arranged relative to the second mold part in a lateral direction of the forming mold and/or the second mold part is movably arranged relative to the first mold part in the lateral direction of the forming mold, wherein the second end of the pressure lance is movably arranged relative to the first mold part and/or the second mold part at least in the lateral direction of the forming mold.

3. (canceled)

4. The product forming unit according to claim 1,
wherein the first end is pivotably connected to a holding structure, wherein upon a pivoting movement of the first end relative to the holding structure the second end is configured for being displaced relative to the first mold part and/or the second mold part.

5. The product forming unit according to claim 1,
wherein the first end is slidingly connected to a holding structure, wherein upon a sliding movement of the first end relative to the holding structure the second end is configured for being displaced relative to the first mold part and/or the second mold part.

6. The product forming unit according to claim 1,
wherein the second mold part is arranged as a stationary mold part and the first mold part is movably arranged relative to the second mold part upon displacement of the forming mold between the open state and the closed state,
wherein upon displacement of the forming mold from the open state to the closed state the first mold part and the second end of the pressure lance are configured for being displaced towards the second mold part, wherein upon displacement of the forming mold from the closed state to the open state the first mold part and the second end of the pressure lance are configured for being displaced away from the second mold part.

7. The product forming unit according to claim 1,
wherein the flexible membrane is configured for being inflated with a pressure medium entering from the pressure lance for applying a forming pressure onto the cellulose fibers by pressing the cellulose fibers against the first mold part and the second mold part by means of the inflated flexible membrane, and the forming mold is configured for applying a forming temperature onto the cellulose fibers, for dry-forming the cellulose product with a three-dimensional compressed fiber structure having a closed bottom portion and an upper portion.

8. The product forming unit according to claim 1,
wherein the forming mold further comprises a first lower mold part and a second lower mold part, wherein upon displacement of the forming mold from the open state to the closed state the first mold part is configured for being moved towards the second mold part in a lateral direction of the forming mold and/or the second mold part is configured for being moved towards the first mold part in the lateral direction of the forming mold,
wherein upon displacement of the forming mold from the open state to the closed state the first lower mold part is configured for being moved towards the second lower mold part in the lateral direction of the forming mold and/or the second lower mold part is configured for being moved towards the first lower mold part in the lateral direction of the forming mold,
wherein upon displacement of the forming mold from the open state to the closed state the first lower mold part and the second lower mold part are configured for being moved towards the flexible membrane in a longitudinal direction of the forming mold.

9. The product forming unit according to claim 8,
wherein the flexible membrane is configured for being inflated with a pressure medium entering from the pressure lance for applying a forming pressure onto the cellulose fibers by pressing the cellulose fibers against the first mold part, the second mold part, the first lower mold part and the second lower mold part by means of the inflated flexible membrane, and the forming mold is configured for applying a forming temperature onto the cellulose fibers, for dry-forming the cellulose product with a three-dimensional compressed fiber structure having a closed bottom portion and an upper portion.

10. The product forming unit according to claim 8,
wherein the first lower mold part is movably connected to the first mold part and configured for being displaced relative to the first mold part in the longitudinal direction of the forming mold, and wherein the second lower mold part is movably connected to the second mold part and configured for being displaced relative to the second mold part in the longitudinal direction of the forming mold.

11. A product forming unit according to claim 1,
wherein the product forming unit comprises a pre-forming mold arranged upstream the forming mold, wherein the pre-forming mold comprises an outer mold part and an inner mold part arranged around a forming section of the pressure lance, wherein a forming cavity is formed between the outer mold part, the inner mold part, and the forming section,
wherein the forming section of the pressure lance is movably arranged relative to the outer mold part and/or the inner mold part between a first position in an open state of the pre-forming mold and a second position in a closed state of the pre-forming mold.

12. The product forming unit according to claim 11,
wherein the product forming unit comprises a shaping unit and a feeding unit, wherein the shaping unit is configured for shaping a cellulose blank structure air-formed from the cellulose fibers into a shaped cellulose blank structure having a tube-like configuration upstream the forming mold, wherein the feeding unit is configured for feeding the shaped cellulose blank structure around the pressure lance and flexible membrane into the forming mold, or wherein the feeding unit is configured for feeding the shaped cellulose blank structure around the pressure lance and flexible membrane into the pre-forming mold and into the forming mold,
wherein the dry-formed cellulose product comprises a neck portion, wherein the upper portion is arranged between the closed bottom portion and the neck portion, wherein the upper portion is arranged in fluid communication with the neck portion,
wherein the feeding unit is configured for feeding the shaped cellulose blank structure to the pre-forming mold, wherein the pre-forming mold is configured for forming a neck portion of a leading cellulose product simultaneously with forming a semi-closed bottom portion of a directly following trailing cellulose product from the shaped cellulose blank structure.

13. (canceled)

14. The product forming unit according to claim 12,
wherein the feeding unit is configured for feeding the shaped cellulose blank structure around the pressure lance and through the outer mold part and the inner mold part when the pre-forming mold is arranged in the open state, wherein the outer mold part and the inner mold part when arranged in the closed state are configured for pressing the shaped cellulose blank structure against the pressure lance for simultaneously forming the neck portion and the semi-closed bottom portion in the forming cavity,
wherein the outer mold part and the inner mold part of the pre-forming mold comprises a thread forming section configured for forming a threaded section of the neck portion upon forming of the neck portion in the pre-forming mold.

15-16. (canceled)

17. The product forming unit according to claim 11,
wherein the product forming unit comprises a fluid control device, wherein the pressure lance at the first end is arranged in fluid communication with the fluid control device, wherein the fluid control device is configured for inflating the flexible membrane with the pressure medium via the pressure lance.

18. A method for dry-forming a cellulose product from cellulose fibers in a product forming unit, wherein the product forming unit comprises a forming mold having a first mold part and a second mold part forming a forming cavity, and a pressure lance comprising a first end and a second end, wherein the second end of the pressure lance is extending to or partly into the forming cavity, and wherein the second end is connected to and arranged in fluid communication with a flexible membrane arranged in the forming cavity, wherein the first mold part and/or the second mold part are movably arranged and the second end of the pressure lance is movably arranged relative to the first mold part and/or the second mold part wherein the method comprises the steps:
displacing the first mold part and/or the second mold part for arranging the forming mold into an open state, and displacing the second end of the pressure lance relative to the first mold part and/or the second mold part into a first position in the open state, wherein in the open state the forming mold is configured for receiving the cellulose fibers into the forming cavity;
displacing the first mold part and/or the second mold part for arranging the forming mold into a closed state, and displacing the second end of the pressure lance relative to the first mold part and/or the second mold part into a second position in the closed state, wherein in the closed state the forming mold is closed around the cellulose fibers in the forming cavity.

19. The method according to claim 18,
wherein the method further comprises the steps: moving the first mold part relative to the second mold part in a lateral direction of the forming mold and/or moving the second mold part relative to the first mold part in the lateral direction of the forming mold upon displacement of the forming mold between the open position and the closed position; wherein the second end of the pressure lance is movably arranged relative to the first mold part and/or the second mold part at least in the lateral direction of the forming mold upon displacement of the forming mold between the open position and the closed position.

20. (canceled)

21. The method according to claim 18,
wherein the first end is pivotably connected to a holding structure, wherein the method further comprises the step: pivoting the first end relative to the holding structure, wherein the pivoting movement of the first end relative to the holding structure is displacing the second end relative to the first mold part and/or the second mold part.

22. The method according to claim 18,
wherein the first end is slidingly connected to a holding structure, wherein the method further comprises the step: sliding the first end relative to the holding structure, wherein the sliding movement of the first end relative to the holding structure is displacing the second end relative to the first mold part and/or the second mold part.

23. The method according to claim 18,
wherein the second mold part is arranged as a stationary mold part and the first mold part is movably arranged relative to the second mold part upon displacement of the forming mold between the open state and the closed state, wherein the method further comprises the steps:
displacing the forming mold from the open state to the closed state, wherein upon displacement of the forming mold from the open state to the closed state the first mold part and the second end of the pressure lance are displaced towards the second mold part;
displacing the forming mold from the closed state to the open state, wherein upon displacement of the forming mold from the closed state to the open state the first mold part and the second end of the pressure lance are displaced away from the second mold part.

24. The method according to claim 18,
wherein the method further comprises the steps: inflating the flexible membrane with a pressure medium entering from the pressure lance for applying a forming pressure onto the cellulose fibers by pressing the cellulose fibers against the first mold part and the second mold part by means of the inflated flexible membrane in the closed state and in the closed state applying a forming temperature onto the cellulose fibers in the forming mold for dry-forming the cellulose product with a three-dimensional compressed fiber structure having a closed bottom portion and an upper portion.

25. The method according to claim 18,
wherein the product forming unit comprises a pre-forming mold arranged upstream the forming mold, wherein the pre-forming mold comprises an outer mold part and an inner mold part arranged around a forming section of the pressure lance, wherein a forming cavity is formed between the outer mold part, the inner mold part, and the forming section, wherein the forming section of the pressure lance is movably arranged relative to the outer mold part and/or the inner mold part, wherein the method further comprises the steps:
displacing the outer mold part and/or the inner mold part for arranging the pre-forming mold into an open state, and displacing the forming section of the pressure lance relative to the outer mold part and/or the inner mold part into a first position in the open state of the pre-forming mold, wherein in the open state the pre-forming mold is configured for receiving the cellulose fibers into the forming cavity;
displacing the outer mold part and/or the inner mold part for arranging the pre-forming mold into a closed state, and displacing the forming section of the pressure lance relative to the outer mold part and/or the inner mold part into a second position in the closed state of the pre-forming mold, wherein in the closed state the pre-forming mold is closed around the cellulose fibers in the forming cavity.
